(19) United States
(12) Patent Application Publication
(10) Pub. No.: US 2025/0182198 A1
(43) Pub. Date: Jun. 5, 2025

(54) SYSTEMS AND METHODS FOR AN INTERACTIVE COMMUNICATION PLATFORM

(71) Applicant: Wells Fargo Bank, N.A., San Francisco, CA (US)

(72) Inventors: Nicolas Benore, San Francisco, CA (US); Kelly Canestrare, San Francisco, CA (US); Nicholas D. Hatfield, San Francisco, CA (US)

(73) Assignee: Wells Fargo Bank, N.A., San Francisco, CA (US)

(21) Appl. No.: 19/049,898

(22) Filed: Feb. 10, 2025

Related U.S. Application Data
(63) Continuation of application No. 17/392,836, filed on Aug. 3, 2021.

(51) Int. Cl. G06Q 40/02; G06Q 20/02; G06Q 20/10; G06Q 20/40; G10L 15/183; G10L 25/63

(52) U.S. Cl. CPC G06Q 40/02; G06Q 20/02; G06Q 20/102; G06Q 20/40; G10L 15/183; G10L 25/63

(57) ABSTRACT

A method for an interactive communication session includes receiving a request regarding a commitment associated with a user; initiating an interactive communication session with a user device; generating a prompt for inclusion in the interactive communication session, the prompt including a first question regarding an expected duration of a hardship; providing the prompt in the interactive communication session such that the prompt is provided via the user device; receiving a reply to the prompt from the interactive communication session; analyzing the reply to determine a confidence of the user in satisfying a modified commitment included with the prompt; comparing the confidence to a predefined confidence threshold; iteratively repeating the receiving, analyzing, and comparing processes until a determined confidence of the user meets or exceeds the predefined confidence threshold; and transmitting an updated term for the user based on the iterative process to the user device.

### CROSS-REFERENCE TO RELATED PATENT APPLICATION

This application is a continuation of U.S. patent application Ser. No. 17/392,836, filed on Aug. 3, 2021, which is incorporated herein by reference in its entirety.

### TECHNICAL FIELD

The present disclosure relates to systems and methods for providing an interactive communication platform that is useable as a tool for a variety of applications, such as revising payment obligation terms of an agreement.

### BACKGROUND

When a provider institution (e.g., a service provider, a financial institution) evaluates users (e.g., clients, customers, patrons, etc.) with respect to the user's ability to satisfy a user's obligation (e.g., a payment obligation), the provider institution may consider various factors associated with the user. The evaluation of the user may lead to an agreement defining a payment obligation between the user and the provider institution. However, the user may not be provided an opportunity to negotiate the terms of the agreement and/or confirm the terms of the agreement (or the evaluation of the user). Further, over time, the user's situation may change such that the same factors that were initially relied upon may become out-of-date. In turn and over time, the user may experience difficulty in meeting their payment obligation and, in some situations, miss required payments or otherwise become delinquent on their obligations under the agreement. In these situations, typically, an impersonal meeting between a representative of the provider institution and the user occurs to attempt to amicably resolve the situation. This type of meeting is often burdensome and uncomfortable, especially for the user. Better systems and methods are desired to enhance the customer experience during, in many cases, a trying time (e.g., financial hardship) of the customer.

### SUMMARY

At least one arrangement relates to a computer-implemented method. The method includes maintaining, by a provider institution computing system, an account of a user having a payment obligation; receiving, by the computing system, a request regarding the payment obligation; identifying, by the computing system, a user device as a source of the request; initiating, by the computing system, an interactive communication session with the user device based on identifying the user device; generating, by the computing system, a prompt for inclusion in the interactive communication session; providing, by the computing system, the prompt in the interactive communication session such that the prompt is provided via the user device; receiving, by the computing system, a reply to the prompt from the interactive communication session; analyzing, by the computing system, the reply to determine a confidence of the user in satisfying a proposed obligation included with the prompt; comparing, by the computing system, the confidence to a predefined confidence threshold; iteratively repeating the receiving, analyzing, and comparing processes until a determined confidence of the user meets or exceeds the predefined confidence threshold; and transmitting, by the computing system, an updated account term for the user account based on the iterative process to the user device and storing the updated account term in a memory of the provider institution computing system.

Another arrangement relates to an apparatus including a processing circuit including a processor and a memory coupled to the processor, the memory containing instructions therein that, when executed by the processor, cause the processing circuit to: receive a request associated with an obligation in an agreement; select a prompt from a plurality of prompts, the selected prompt configured to illicit a user input from a user device associated with a user, the user input associated with revising the obligation in the agreement; continue to select at least one subsequent prompt from the plurality of prompts until the processing circuit determines that a received user input regarding a modified obligation included within the at least one subsequent prompt for the agreement satisfies a predefined confidence threshold; and transmit an agreement including the modified obligation to the user device.

Still another arrangement relates to another computer-implemented method. The method includes initiating, by a provider institution computing system, an interactive communication session with a user operating a user device; providing, by the provider institution computing system, a chat bot that provides a prompt and receives a reply during the interactive communication session; receiving, by the chat bot of the provider institution computing system, a request associated with an obligation of an agreement of the user associated with the computing system; iteratively proposing and receiving, by the chat bot of the provider institution computing system, a proposed revision to the obligation and a reply to the proposed revision to the obligation; determining, by the provider institution computing system, that the reply regarding the proposed revision satisfies a predefined confidence threshold; modifying, by the provider institution computing system, one or more obligations in the agreement based on the proposed revision; and transmitting, by the provider institution computing system, a modified agreement including the modified one or more obligations to the user device of the user.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 illustrates a block diagram of a computing system of an interactive communication platform for revising payment obligation terms, according to an example embodiment.

FIG. 2 illustrates a flow diagram of a method for revising payment obligation account terms, according to an example embodiment.

FIG. 3 illustrates a block diagram of an example system using supervised learning that may be used to determine a true confidence of a user during an interactive communication session, according to an example embodiment.

FIG. 4 illustrates a block diagram of a simplified neural network that may be used to determine a true confidence of a user during an interactive communication session, according to an example embodiment.

FIG. 5 illustrates a simplified reinforcement learning model that may be used to determine a true confidence of a user during an interactive communication session, according to an example embodiment.

FIGS. 6A-6D illustrate graphical user interfaces of a chat between a virtual assistant and a user via the interactive communication session for revising or modifying one or more payment obligation terms, according to an example embodiment.

### DETAILED DESCRIPTION

Referring generally to the Figures, systems and methods for revising user obligations (e.g., terms of the agreement, such as payment obligation terms) using an interactive communication platform are disclosed, according to various embodiments herein. The systems and methods described herein improve user relationships with a provider institution (e.g., a financial institution that manages the obligation, such as a loan) by proactively identifying, revising and/or generating agreement terms for payment obligations which, as described herein, are existing payment obligations (e.g., an existing loan or other payment obligation). Revising the agreement terms may reduce the likelihood of a user violating the terms of the agreement thereby positively affecting the user's reputation (e.g., a credit score).

Conventionally, a user (e.g., a customer or a client) may have or obtain an account with a provider institution (e.g., a financial institution, a merchant, a health care institution, the government, or an employer). The account may be associated with an agreement that defines a payment obligation. Accordingly, the account may be a loan such (e.g., mortgage, vehicle loan, etc.). Terms of the agreement may include a minimum payment amount, a payment due frequency (e.g., monthly, bi-monthly, etc.), an interest rate, a term of the payment obligation, and so on. As part of the account opening (loan) process, the provider institution may statically evaluate the user. For example, when the provider institution underwrites the user for a given loan, the provider institution may consider various factors, such as the user's income, history of income, and reason(s) for requesting the loan. The provider institution determines the terms of the agreement (e.g., obligations associated with the agreement such as the amount of the loan, minimum monthly payments, interest, etc.) based on the various factors. The factors that the provider institution initially uses to evaluate the user may change over time. Accordingly, original assumptions, calculations and/or evaluations that the provider institution initially made may become stale. In some undesired occurrences, the user may have trouble meeting (or satisfying) the terms of the original agreement and thus the account associated with the agreement may become troubled.

As described herein, a computing system of the provider institution may evaluate the terms of the agreement associated with the account based on an identified hardship (i.e., troubled account situation) via an interactive communication session between the user via a user device associated with the user and the computing system. For example, a user may provide a notification to the provider institution computing system that a term of the agreement needs to be modified and/or revised (or, generally, indicate a hardship in their financial situation). Additionally or alternatively, the provider institution computing system may proactively notify the user that the user account has become a troubled account (i.e., a “troubled account” or “delinquent account”), such as based on there being a predefined number of late payments or the user paying below the minimum required amount a predefined number of instances, a combination thereof, etc. The provider institution computing system and user, via the user computing device, may subsequently enter into an interactive communication session that iteratively prompts the user for an input, receives the user input, and evaluates the confidence of the user input until the confidence of the user input satisfies a threshold to then update, revise, or otherwise adjust the terms of the user's pre-existing payment obligation in a seamless and collaborative way. The confidence threshold is used to assess the user's confidence in meeting this updated agreement term thereby ensuring or attempting to ensure an ability of the user to meet the updated agreement terms.

Beneficially, the provider institution computing system is identifying updated terms that are more likely to be satisfied by the user via the interactive communication session with the user, which may lead to less delinquent account statuses, less late or missed payments, an improved user relationship, and an overall better user experience. Additionally, the provider institution increases collectability and reduces loss rates using a plan that is more catered to the user's specific needs. The provider institution offers a personalized plan that the user has confidence in being able to satisfy based on the interactive communication session. The interactive communication session increases a user's self-service engagement and reduces the provider system's operational risk by facilitating deep user relationships and adherence to agreement terms. Provider institutions that offer user centric plans may be more likely to find that their users stay loyal. The interactive communication session facilitates deeper user relationships by iteratively learning about the user's situation using a plurality prompts. Accordingly, the user may feel that they have a relationship with the provider institution (e.g., the user is not just a number), the provider institution is taking into consideration the user's specific needs, and the user is given flexibility by being presented options. The interactive communication system uses a consistent, quantitative framework to resolve (or identify or address) user hardships.

The systems and methods described herein provide many benefits over existing computing systems. For example, iteratively interacting with a user until the interactive communication platform computing system determines that the user is confident that the user can satisfy one or more updated terms of the account may reduce current or expected computational resources and traffic transmitted over a network. A user who has adjusted the terms of their account (such as the terms associated with a payment obligation) reduces network traffic by minimizing current or expected reminders transmitted to the user. For example, reminders may not need to be transmitted to the user, reminding the user of the troubled account and/or requesting the user to take an action associated with their account (e.g., to make a payment). Accordingly, computational resources are conserved by the provider institution computing system by not continuously generating reminders to transmit to the user. Similarly, computational resources are conserved by the user device by not receiving and processing reminders from the provider institution computing system. Instead, a discrete computing session is provided that may minimize overall computer resource consumption (e.g., processing and generating of reminders, storing of reminders, printing and physically mailing of reminders may be reduced or avoided, etc.). Moreover, the iterative communication session may decrease current and/or expected traffic in a network by providing proposed terms/obligations that are specific to the user. By providing tailored or specific terms/obligations to the user, the provider institution computing system reduces current or future computational resources by minimizing the number of iterations in the interactive communication session before the user is confident in the user's ability to satisfy the updated/modified obligations of the agreement. These and other features and benefits are described more fully herein below.

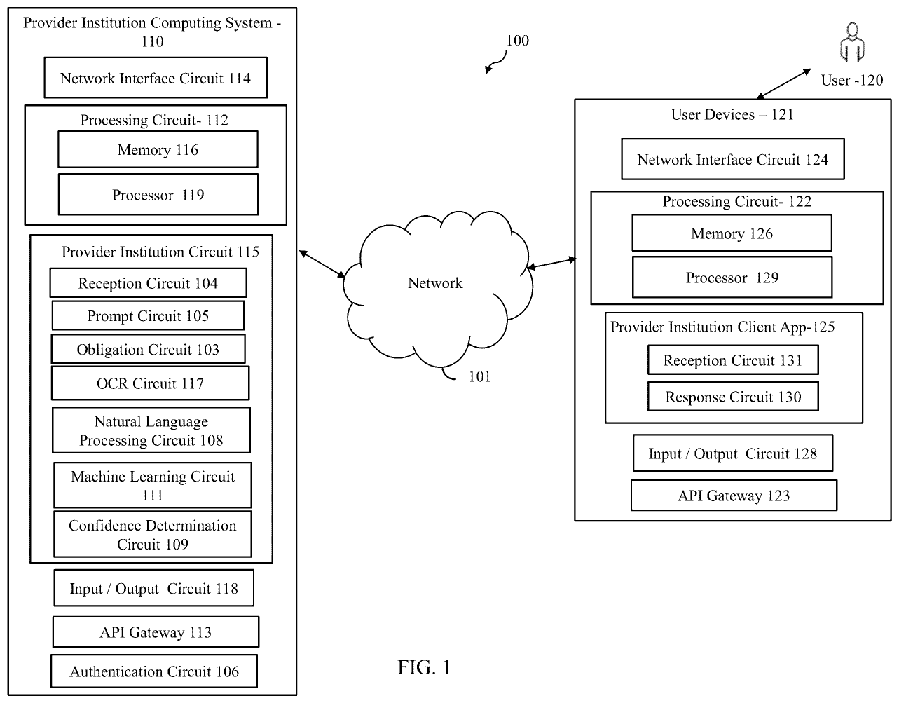

Referring now to FIG. 1, a block diagram of a computing system of an interactive communication platform for revising obligations is shown, according to an example embodiment. The interactive communication platform computing system 100 includes user devices 121 associated with users and a provider institution computing system 110 associated with a provider institution. Devices and components in FIG. 1 can be added, deleted, integrated, separated, and/or rearranged in various embodiments of the disclosed embodiments. The various systems and devices may be communicatively and operatively coupled through a network 101. Network 101 may permit the direct or indirect exchange of data, values, instructions, messages, and the like (represented by the arrows in FIG. 1). The network 101 may include one or more of the Internet, cellular network, Wi-Fi, Wi-max, a proprietary network, or any other type of wired or wireless network of a combination of wired or wireless networks.

The user 120 may be any person using the user device 121. The user 120 may be an authorized user (e.g., the owner of the device 121, the owner of the account of the provider institution, and the like). The user 120 may be an individual, business representative, large and small business owner, and so on. In the example shown, the user 120 is a customer or client of the provider institution associated with the provider institution computing system 110.

The user device 121 includes any type of electronic device that a user 120 can use to communicate with the provider institution computing system 110. For example, the user device 121 may include watches (e.g., a smart watch), glasses (e.g., eye glasses, sunglasses, smart glasses, etc.), bracelets (e.g., a smart bracelet), standalone computers (e.g., laptop computers, desktop computers, etc.), and/or mobile devices (e.g., smart phones, personal digital assistants, tablet computers, etc.). In the example shown, the user device 121 is a mobile device and, particularly, a smartphone. As shown, the user device 121 includes a network interface 124, a processing circuit 122, which may include a memory 126 coupled to a processor 129, an provider institution client application 125, an input/output circuit 128, and an application programming interface (API) gateway 123.

The network interface circuit 124 is structured to receive communications from and provide communications to the provider institution computing system 110. In this regard, the network interface circuit 124 is structured to exchange data, communications, instructions, and the like with the provider institution computing system 110.

The network interface circuit 124 of the user device 121 is structured or adapted for and configured to establish a communication session via the network 101 with the provider institution computing system 110. The network interface circuit 124 includes programming and/or hardware-based components that couple the user device 121 to the network 101. For example, the network interface circuit 124 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 124 includes the hardware and machine-readable media structured to support communication over multiple channels of data communication (e.g., wireless, Bluetooth, near-field communication, etc.). Further, in some arrangements, the network interface circuit 124 includes cryptography module(s) to establish a secure communication session (e.g., using the IPSec protocol or similar) in which data communicated over the session is encrypted and securely transmitted. In this regard, financial data (or other types of data) may be encrypted and transmitted to prevent or substantially prevent the threat of hacking or unwanted sharing of information.

To support the features of the user device 121, the network interface circuit 124 provides a relatively high-speed link to the network 101, which may be any combination of a local area network (LAN), an intranet (e.g., a private banking or retailer network), the Internet, or any other suitable communications network, directly or through another interface.

The processing circuit 122 may include at least one memory 126 coupled to a processor 129. The memory 126 includes one or more memory devices (e.g., RAM, NVRAM, ROM, Flash Memory, hard disk storage) that store data and/or computer code for facilitating at least some of the various processes described herein. That is, in operation and use, the memory 126 stores at least portions of instructions and data for execution by the processor 129 to control the processing circuit 122. The memory 126 may be or include tangible, non-transient computer-readable volatile memory and/or non-volatile memory. The processor 129 may be implemented as one or more processors, application specific integrated circuits (ASICs), field programmable gate arrays (FPGAs), digital signal processors (DSPs), and/or other suitable electronic processing components.

The user device 121 is configured to run a variety of application programs and store associated data in a database of the memory 126, for instance. One such application run by the user device 121 (and executed via the processing circuit 122) may be the provider institution client application 125. The provider institution client application 125 is a downloaded and installed application that includes program logic stored in a system memory (or other storage location) of the user device 121 that includes a reception circuit 131 and a response circuit 130. In this embodiment, the reception circuit 131 and response circuit 130 are embodied as program logic (e.g., computer code, modules, etc.). The provider institution client application 125 is communicably coupled via the network interface circuit 124 over the network 101 to the provider institution computing system 110 and, particularly to the provider institution circuit 115 that may support at least certain processes and functionalities of the client application 125. During download and installation, and in some embodiments, the provider institution client application 125 is stored by the memory 126 of the user device 121 and selectively executable by the processor 129. The program logic may configure the processor 129 of the user device 121 to perform at least some of the functions discussed herein. In some embodiments the provider institution client application 125 is a stand-alone application that may be downloaded and installed on the user device 121. In other embodiments, the provider institution client application 125 may be a part of another application, such as another provider institution client application. For example and in the embodiment depicted where the provider institution is a financial institution, the client application 125 may be a part of a mobile banking application provided and supported by the provider institution computing system 110.

The depicted downloaded and installed configuration of the client application 125 is not meant to be limiting. According to various embodiments, parts (e.g., modules, etc.) of the provider institution client application 125 may be locally installed on the user device 121 and/or may be remotely accessible (e.g., via a browser-based interface) from the provider institution computing system 110 (or other cloud system in association with the provider institution computing system 110). In this regard and in another embodiment, the provider institution client application 125 is a web-based application that may be accessed using a browser (e.g., an Internet browser provided on the user device). In still another embodiment, the provider institution client application 125 is hard-coded into memory such as memory 126 of the user device 121 (i.e., not downloaded for installation). In an alternate embodiment, the provider institution client application 125 may be embodied as a “circuit” of the user device 121 as circuit is defined herein.

The provider institution client application 125 is structured to perform a variety of functions and/or processes to transform operation of the user device 121. As described herein, the provider institution client application 125 may generate and provide an interactive communication session such the user 120 may iteratively communicate with the provider institution computing system 110 to revise and/or modify one or more account terms (e.g., payment obligations) until the user 120 is confident in their ability to satisfy (meet) the account terms.

The response circuit 130 of the provider institution client application 125 is structured to generate and provide a plurality of prompts to the user 120, receive a user input (e.g., a reply or response to the prompt), and transmit the user input to the provider institution computing system 110. The response circuit 130 may be structured to transmit audio user responses to a reception circuit 104 of the provider institution computing system 110. In some configurations, the response circuit 130 may activate a microphone of the user device 121 (e.g., using the input/output circuit 128) such that the microphone captures audio from the user 120. For instance, the response circuit 130 may capture audio data in response to an audio prompt provided by the response circuit 130 (via a speaker of the user device 121). The captured audio data may be transmitted, via the network interface circuit 124 of the user device 121, to the provider institution computing system 110. In some configurations, the response circuit 130 may request permission from the user 120 before activating the microphone and/or request that the user 120 accept usage of the microphone.

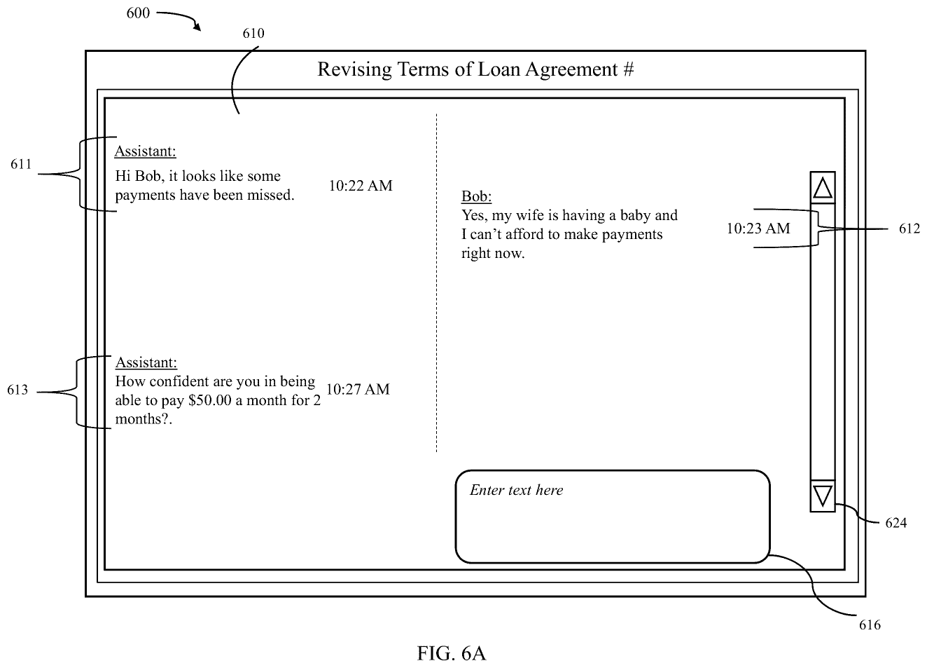

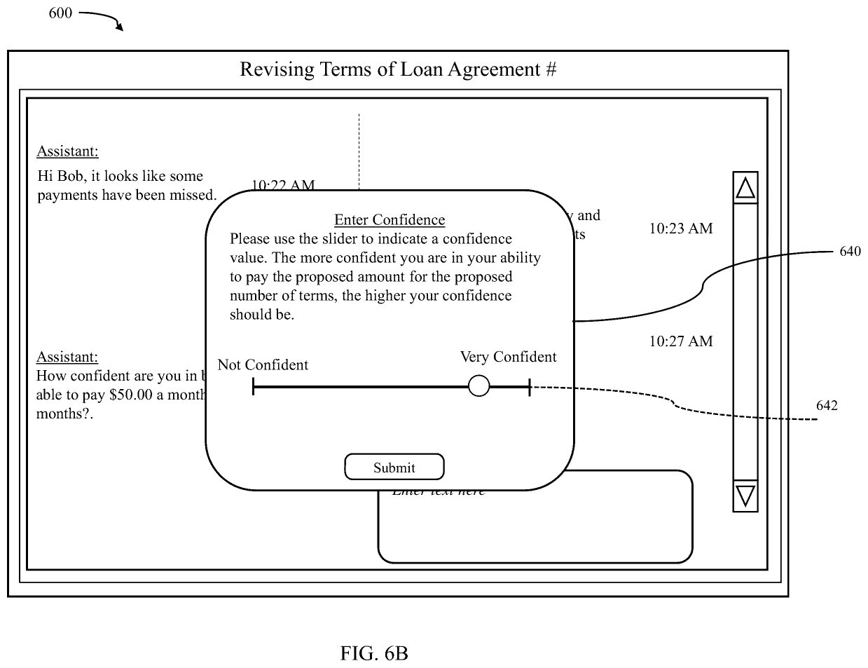

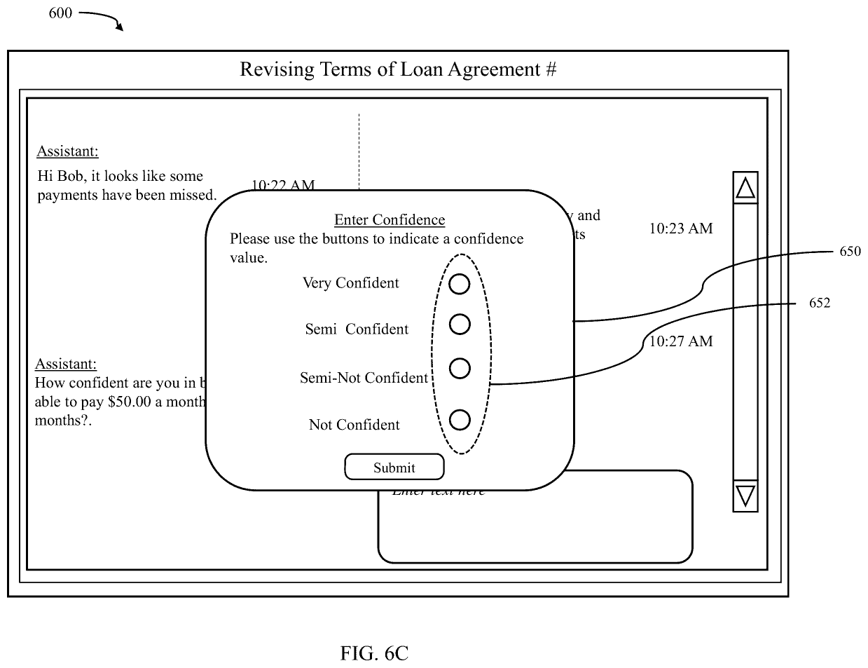

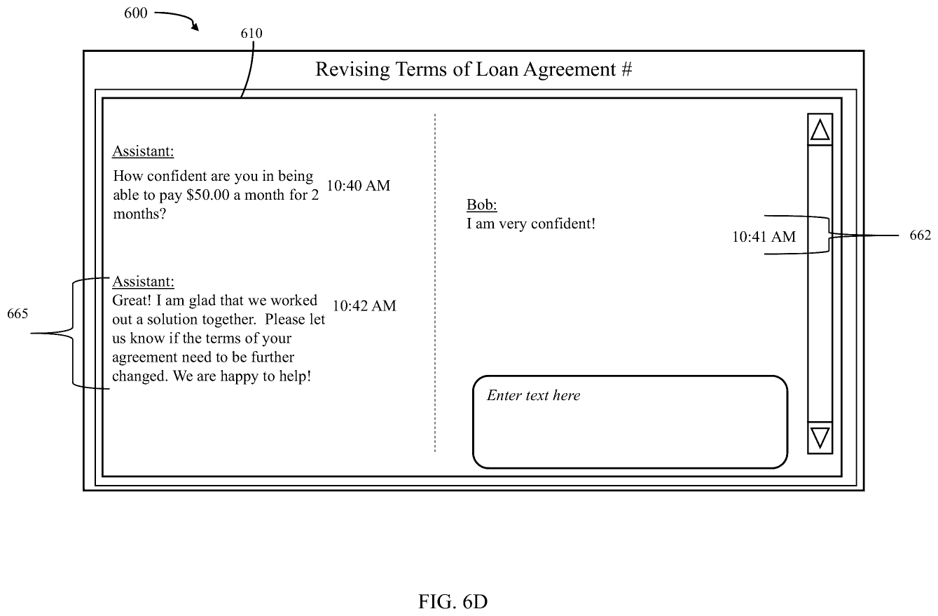

The response circuit 130 may also capture non-audio user responses in response to the provider institution client application 125 generating and displaying a user interface (e.g., a graphical user interface such as FIGS. 6A-6D) having one or more prompts during the interactive communication session. Non-audio user responses may include text entries and/or digital selections. For example, the response circuit 130 may capture a text entry or capture a selection from a predetermined list of user inputs (e.g., drop down menus, slider, button) using the input/output circuit 128 of the user device 121. For instance, the user 120 may interact with t dynamically changing user interfaces, such as that shown in FIGS. 6A-6D herein, so that the provider institution computing system 110 receives user replies during the interactive communication session.

The response circuit 130 may also activate a camera of the user device 121 (e.g., using the input/output circuit 128) such that the camera captures visual data from and regarding the user 120. Visual data captured by the response circuit 130 may include a user's thumbs-up or thumbs-down in response to prompts received by the reception circuit 131 (or other visual cue) in response to one or more prompts. For example and during the interactive communication session, a prompt asking the user if they are comfortable with a certain revised payment amount (i.e., updated/modified agreement term) may be displayed via a GUI of the user device 121. In response, the user may physically put their thumbs up. This visual cue is captured by the camera of the user device 121, analyzed by the client application 125, and determined to correspond with an acceptance of that prompt. Here, the provider institution client application 125 may either include a table or other information regarding commonly used cues (thumbs up, thumbs down, head shaking up/down, etc.) so that motions of the user are correctly analyzed and determined. In some embodiments, the captured motion may be transmitted to the provider institution computing system 110 for analysis to determine if the user accepted/denied the prompt. In some configurations, the response circuit 130 may request permission from the user 120 before activating the camera and/or request that the user 120 accept usage of the camera. Additionally, the response circuit 130 may provide a reply prompt to the captured user motion to confirm the analysis (e.g., “It appears you approve this new payment amount, can you confirm?”).

The reception circuit 131 of the provider institution client application 125 may be structured to receive a revised agreement or parts thereof (e.g., a revised term of an existing agreement) regarding a user account, such as a loan account, from the provider institution client application 125. For example, one or more payment obligations terms, such as the monthly payment amount, may be revised by the provider institution circuit 115, transmitted over the network to the user device 121, and received by the reception circuit 131 via the network interface circuit 124 of the user device 121. The reception circuit 131 may also be structured to receive proposed revised agreements (and proposed revised terms/obligations) associated with the account and/or a newly generated agreement (with newly generated terms/obligations) from the provider institution computing system 110. The reception circuit 131 may communicate with the provider institution computing system via the network 101.

The input/output circuit 128 includes communication circuitry for facilitating the exchange of data, values, messages, and the like between an input/output device and the user 120 of the user device 121. In yet another embodiment, the input/output circuit 128 includes machine-readable media for facilitating the exchange of information between an input/output device and the user 120. In still another embodiment, the input/output circuit 128 includes any combination of hardware components, communication circuitry, and machine-readable media. Hardware components can include a touchscreen, a keypad, microphone, camera, or buttons for receiving user inputs. Components of the input/output circuit 128 display text, and/or transmit audio to/from the user 120. For example, the input/output circuit 128 may be configured to capture audio from the user 120 (using a microphone, for instance) and/or capture tones such as dual-tone multi-frequency (DTMF) signals selected by the user 120 (using a keypad, for instance). Additionally or alternatively, the input/output circuit 128 may be configured to display graphics such as menus, instructions, questions, background photos (e.g., advertisements, etc.), logos, dynamic GUIs and so on generated by the provider institution client application 125 (or provider institution circuit 115, for instance). In one embodiment, the display is a touchscreen display that is capable of detecting user 120 touches, e.g., to provide user inputs. In other embodiments, the user 120 may generate user inputs via a mouse, keyboard, and the like.

In an example, a display presented to the user 120 using the input/output circuit 128 may display a prompt for the user 120 that is generated and provided by the provider institution client application 125 during the interactive communication session. That prompt may be a question or query to the user 120 regarding one or more terms or obligations of the agreement associated with the user account (e.g., a payment obligation term associated with a mortgage loan). The user 120 may respond to the displayed prompt using a graphical button, a graphical slider, a drop-down menu, a text entry box, a hand gesture (or other user motion), and the like. The user response may be captured by the response circuit 130 of the client application 125.

The user device 121 may also include an API gateway 123. The API gateway 123 may be configured to facilitate the transmission, receipt, authentication, data retrieval, and/or exchange of data between the components (e.g., applications, etc.) of the user device 121 and/or provider institution computing system 110.

An API is a software-to-software interface that allows a first computing system of a first entity to utilize a defined set of resources of a second (external) computing system of a second (third-party) entity to, for example, access certain data and/or perform various functions. In such an arrangement, the information and functionality available to the first computing system is defined, limited, or otherwise restricted by the second computing system. To utilize an API of the second computing system, the first computing system may execute one or more APIs or API protocols to make an API “call” to (e.g., generate an API request that is transmitted to) the second computing system. The API call may be accompanied by a security or access token or other data to authenticate the first computing system and/or a particular user. The API call may also be accompanied by certain data/inputs to facilitate the utilization or implementation of the resources of the second computing system, such as data identifying users (e.g., name, identification number, biometric data), accounts, dates, functionalities, tasks, etc. The API gateway 123 in the user device 121 provides various functionality through APIs by accepting API calls via the API gateway 123. The API calls may be generated via an API engine of a system or device (e.g., user device 120 and/or provider institution computing system 110) to, for example, make a request from another system or device.

Still referring to FIG. 1, the interactive communication platform computing system 100 also includes a provider institution computing system 110. The provider institution computing system 110 is associated with a provider institution, such as financial institution. The provider institution may be a bank, credit union, credit card company, and so on. As described herein, the provider institution may generate, maintain, and associate accounts with a plurality of users (customers or clients). The “account” may be any type of account maintained by the provider institution, such as a demand deposit account, savings account, etc. As described herein, the “account” includes a payment obligation (e.g., a loan). However, other accounts that do not include payment obligations, such as the savings account mentioned above, may also be maintained by the provider institution. One example account with a payment obligation may be a mortgage loan account associated with a particular user. The mortgage loan account may include a mortgage loan agreement with various mortgage loan obligations (monthly payment amount, duration of monthly payments, interest, and the like). Another example account with a payment obligation may be a credit card loan account. Still another example account with a payment obligation may be a student loan account. Yet another example account with a payment obligation may be a medical bill account, home equity line of credit account, and so on. Thus and as described herein, the provider institution, via the provider institution computing system 110, may service one or more payment obligation accounts (e.g., home mortgage, etc.) of the user.

The provider institution computing system 110 may be structured as one or more server computing systems, for example, comprising one or more networked computer servers having a processor and non-transitory machine readable media. In the example shown, the provider institution computing system 110 includes a network interface circuit 114, a processing circuit 112 having a memory 116 and a processor 119, a provider institution circuit 115, an input/output circuit 118, an API gateway 113, and an authentication circuit 106.

The network interface circuit 114 is structured to receive communications from and provide communications to the user 120 via the user device 121. The network interface circuit 114 is structured to exchange data, communications, instructions, and the like with the user device 121. The network interface circuit 114 of the provider institution computing system 110 is structured or adapted for and configured to establish a communication session via the network 101 with the user device 121. The network interface circuit 114 includes programming and/or hardware-based components that connect the provider institution computing system 110 to the network 101. For example, the network interface circuit 114 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 114 includes the hardware and machine-readable media structured to support communication over multiple channels of data communication (e.g., wireless, Bluetooth, near-field communication, etc.) Further, in some arrangements, the network interface circuit 114 includes cryptography module(s) to establish a secure communication session (e.g., using the IPSec protocol or similar) in which data communicated over the session is encrypted and securely transmitted. In this regard, financial data (or other types of data) may be encrypted and transmitted to prevent or substantially prevent the threat of hacking or unwanted sharing of information. To support the features of the provider institution computing system 110, the network interface circuit 114 provides a relatively high-speed link to the network 101, which may be any combination of a local area network (LAN), an intranet (e.g., a private banking or retailer network), the Internet, or any other suitable communications network, directly or through another interface.

The processing circuit 112 may include at least one memory 116 coupled to a processor 119. The memory 116 includes one or more memory devices (e.g., RAM, NVRAM, ROM, Flash Memory, hard disk storage) that store data and/or computer code for facilitating at least some of the various processes described herein. That is, in operation and use, the memory 116 stores at least portions of instructions and data for execution by the processor 119 to control the processing circuit 112. The memory 116 may be or include tangible, non-transient volatile memory and/or non-volatile memory. The processor 119 may be implemented as one or more processors, application specific integrated circuits (ASICs), field programmable gate arrays (FPGAs), digital signal processors (DSPs), and/or other suitable electronic processing components.

The memory 116 may hold, store, categorize, and/or otherwise serve as a repository for the accounts (including the agreements, obligations, and the like) and activities of account holders (e.g., users 120) of the provider institution computing system 110. The memory 116 may be structured to provide information relating to accounts, such as an account number, account balance (e.g., in accounts with and without payment obligations), user name, user contact information (e.g., email address, physical address, phone number of the account holder), and so on. Thus, the memory 116 may track and store activity regarding the accounts maintained by the provider institution (e.g., track missed or late payments, track payments made and dates when made, track payment amount dates, etc.).

The provider institution circuit 115 is structured to at least partly support the provider institution client application 125. In one embodiment, the provider institution circuit 115 is a circuit (e.g., processing circuit) of the provider institution computing system 110. In another embodiment, the provider institution circuit 115 is embodied as program logic (e.g., modules, etc.) that may be stored by the memory 116 and executed by the processor 119. The program logic may configure the processor 119 of the provider institution computing system 110 to perform at least some of the functions discussed herein. In the example shown, the provider institution circuit 115 is a dedicated hardware circuit including program logic that supports and enables at certain processes described herein. However, this depiction is not meant to be limiting.

The authentication circuit 106 may be configured to authenticate the user 120 (or the user device 121) via authenticating information received from the user device 121. In some configurations, the provider institution computing system 110 may not establish a communication session with the provider institution client application 125 to modify/revise a term of an existing agreement associated with a user 120 account unless the user 120 (and/or the user device 121) has been authenticated via the authentication circuit 106. For example, the authentication circuit 106 may receive a credential (username and password, answer to security question, passcode, biometric information, etc.) to initiate the communication session such that the provider institution circuit 115 deploys resources for an authenticated communication session only when needed thereby improving overall operation of the computing system by deploying resources in an on-demand manner. This authentication may be in addition to or in place of authentication that may be required to access/use the provider institution client application 125.

The authentication circuit 106 authenticates a user 120 as being a valid account holder associated with the provider institution computing system 110. In some embodiments and as alluded to above, the authentication circuit 106 may prompt the user 120 to enter user 120 credentials (e.g., username, password, security questions, and biometric information such as fingerprints or facial recognition). The authentication circuit 106 may look-up and match the information entered by the user 120 to stored/retrieved user 120 information in memory 116. For example, memory 116 may contain a lookup table matching user 120 authentication information (e.g., name, home address, IP address, MAC address, phone number, biometric data, passwords, usernames) to stored user 120 accounts.

The provider institution circuit 115 is structured to perform a variety of functions to iteratively and continuously communicate with a user (e.g., a user 120 over a network 101) in order to revise and/or modify one or more account terms (e.g., payment obligations) utilizing other circuits of the provider institution computing system 110 as described herein. The provider institution circuit 115 is shown to include a reception circuit 104, a prompt circuit 105, an obligation circuit 103, an optical character recognition circuit (OCR) 117, a natural language processing (NLP) circuit 108, a machine learning circuit 111, and a confidence determination circuit 109. In this embodiment, the circuits of the provider institution circuit 115 are embodied as program logic.

The reception circuit 104 may be structured to receive a request for an obligation revision and/or obligation generation request from the provider institution client application 125. For example, a user 120 may identify a hardship (e.g., a financial hardship with meeting their existing payment obligation) and transmit a request to the reception circuit 104 to initiate an interactive communication session to modify an existing payment obligation (e.g., modify the terms of a loan). The reception circuit 104 may also be structured to receive one or more triggers to initiate an interactive communication session from the provider institution computing system 110 (e.g., a different circuit of the provider institution computing system 110), or from third parties.

In an example, the provider institution computing system 110 may receive an authorization (e.g., user credentials, user acknowledgement, etc.) to monitor one or more accounts of the user 120. The accounts may be accounts associated with the provider institution computing system 110 or accounts associated with third parties. Via the API gateway, the provider institution computing system 110 may communicably link to a third party computing system to monitor an account held by the third party. For example, the customer may have one or more accounts at various third parties (e.g., financial institutions) relative to the provider institution. The user 120, via the provider institution client application 125, may provide a credential for accessing the third-party account which provides the credential to the provider institution computing system 110. In response and via the API gateway, the provider institution computing system 110 may couple to the third party computing system to receive account information regarding a third party account of the user. In this way, the provider institution computing system 110 may be able to gain information to understand a full or nearly full financial picture of the user. This information may be used by the provider institution computing system 110 to assess the confidence in the user's purported ability to satisfy one or more updated/modified agreement obligations.

In some embodiments and in response to one or more trigger conditions identified by monitoring the user account, (e.g., a user's 120 monthly income drops a threshold amount, a predetermined number of missed/late payments has been satisfied, or other delinquent events), the provider institution computing system 110 may generate a notification regarding a troubled or potentially troubled user account and command the reception circuit 104 to initiate a communication session between the user 120 and the provider institution computing system 110. In this way, the “triggering conditions” may signify a troubled account or a potential troubled account which leads to initiation of an interactive communication session. As described herein, initiating the communication session includes executing a chat bot to interact with the user 120. The chat bot may be provided and supported by one or more of the provider institution computing system 110 circuits described herein. The chat bot may iteratively query the user 120 using prompts selected (or identified) by a prompt circuit 105 to identify and propose revised terms (of the existing agreement resulting in the troubled account) until the user 120 is confident in being able to satisfy the revised terms.

The reception circuit 104 may also be structured to receive a user response from the response circuit 130 of the provider institution client application 125. The reception circuit may receive audio user inputs, textual user inputs (e.g., sentences such as “I am feeling pretty confident. I am feeling 80% confident that I can meet the new payment obligation.”, etc.), descriptive quality confidence indicators (e.g. low confidence, medium confidence, high confidence), numerical values indicative of a user's desired updated term (e.g., their requested new periodic payment amount, etc.), digital button user inputs, digital slider user inputs, graphical user inputs, and the like.

The prompt circuit 105 may be configured to generate and provide a query, prompt, and/or otherwise illicit a user 120 response associated with an agreement to the user device 120 (e.g., to the provider institution client application 125 that provides the prompt via, for example, a display device of the device 120). As described herein, the agreement is an existing agreement (e.g. the agreement and the terms of the agreement may be stored in memory 116) having one or more payment obligations with associated terms. During the interactive iterative communication session between the user 120 via the provider institution client application 125 and the provider institution via the provider institution circuit 115, one or more terms of the existing agreement may be modified and the entire agreement updated. The prompt circuit 105 may be used to communicate prompts (queries) associated with the generation and/or revision of the agreement (or terms/obligations of the agreement). In an example, an agreement between a user 120 and a provider institution may be a loan. Terms of the agreement include the payment obligations of the agreement such as the duration of the payment obligation, monthly payment amount, interest, and the like.

The prompt circuit 105 may communicate a prompt to the user 120 by generating and providing a GUI to the user (as shown in FIGS. 6A-6D). Additionally or alternatively, the prompt circuit 105 may communicate a prompt to the user 120 by instructing the provider institution client application 125 to perform an action. For instance, the prompt circuit 105 may instruct the provider institution client application 125 to active a speaker on the user device 121 to audibly communicate a prompt to the user 120. Thus, the prompt may be provided and generated by either the provider institution client application 125 directly or via the prompt circuit 105 and communicated to the client application 125. In one embodiment, the prompt circuit 105 may generate a plurality of prompts based on a plurality of user interactive communication sessions, and transmit the plurality of prompts, or a portion thereof, to the user devices 121. The user devices 121, via the provider institution client application, may store these prompts for quick retrieval and usage during subsequent interactive communication sessions.

The prompts (or queries) that may be selected, identified, or otherwise determined by the prompt circuit 105 (or, in some embodiments, the client application 125) may include one or more questions, statements, inquiries, etc. configured to determine a confidence value (e.g., score or other indicator) regarding the sincerity and belief/confidence in the user's ability to satisfy a proposed obligation (i.e., term of the agreement, such as a modified payment amount). In some implementations, one or more prompts selected by the prompt circuit 105 may be identified as mandatory (required) prompts. Mandatory prompts may be prompts selected and communicated to the user 120 during each established interactive communication session. For example, mandatory prompts may include regulatory prompts or other prompts that are selected pursuant to standards, laws, guidelines, and the like (i.e., standard FFEIC questions that relate to the reason for the hardship, duration of the hardship, an expected time frame until resolution of the identified hardship, etc.). In one embodiment, these standard prompts (e.g., the FFEIC questions) are always the first question or questions provided during the interactive communication session. The prompt selection circuit 105 may also select other prompts including probing queries, recommendation queries, and/or informational queries. Probing queries, informational queries, and/or recommendation queries may be determined by the prompt circuit 105 and provided subsequent to the mandatory prompts. Moreover, these subsequent prompts may be custom/specific to the user and their account to create a personable interactive communication session, which may be appealing to the customer.

Probing queries refer to queries prompting or inviting the user 120 to think about the user's life generally (e.g., asking the user 120 to think about other bills, asking the user 120 to think about the user's family, asking the user 120 to think about the user's goals). Examples of probing queries include, but are not limited to: “In a few words, can you tell me what caused your current situation?”, “Thinking about your current situation, and your currently monthly expenses and income, how much could you afford to pay monthly?,” “Thinking about your current situation, how many months do you think it will be before you can make your normal monthly payment of $X again?”, “Are there other debts that you are concerned about?” In this way, the probing query is intended to gain information regarding the user's hardship (e.g., a cause for the hardship), information regarding the user's financial situation (e.g., information regarding the user's accounts, accounts stored at third parties, etc.), and any other information regarding the user 120.

Recommendation queries refer to queries that evaluate whether the user 120 wants to initiate one or more recommendations, such as one or more product or service recommendations (e.g., enrolling in a financing course, starting a savings account, etc.). Such recommendations may be useful in addressing the user's currently identified hardship.

Informational queries refer to queries that are associated with evaluating the user's confidence with one or more proposed (or generated) terms/obligations of the agreement and/or account from the provider institution computing system 110. While a different term relative to probing query is used, in some embodiments, there may be no difference between information, recommendation, and probing queries. Information queries may ask or prompt the user 120 with respect to a proposed monthly payment amount, a duration of payments at that amount, whether a lump sum payment is feasible, and so on. Example information queries may include, but are not limited to: “Do you have any income sources?”; “What is your income source?”; “Are you able to make your normal monthly payments of $X?”; “Are you able to make any payments at this time?”; “Are you confident that you can make a payment of $X for the next Y months, then resume your normal payment?”; etc.

The prompt circuit 105 may select, determine, or otherwise identify queries (or questions) to transmit to the user device 121 according to a predetermined order or sequence of queries to be asked to the user 120. There may be an entire series of queries that may be transmitted to the user 120 to try to get a better understanding of what the user 120 hardship is and how the terms/obligations (e.g., payment amounts, duration of modified payments) can be modified by the obligation circuit 103 to accommodate the identified hardship. In one embodiment, the determined or selected prompts (e.g., queries) are predefined according to a predefined list. As mentioned above, the standard FFEIC prompts may be provided first followed by a dynamic arrangement of prompts structured to modify existing term(s) of the user's payment obligations of their agreement. In this way and following the FFEIC prompts, the determined or selected prompts are dynamically chosen/selected via the prompt circuit 105 in response to a user's inputs. For example and in one embodiment, the prompt circuit 105 may employ a directed acyclic graph to select queries in response to user responses.

In one embodiment, the prompt circuit 105 may employ a lookup table (or, another process or algorithm) to select prompts to transmit to the user device 121. These prompts may be tied to determining user confidences with meeting or satisfying proposed term revisions to the agreement (e.g., proposed payment amount changes). For example, the prompt circuit 105 may map prompts and potential replies to a user confidence score in order to determine the user confidence score. As discussed further herein, the confidence determination circuit 109 and/or machine learning circuit 111 may determine the user confidence score (e.g., value) based on a user response to a prompt transmitted to the reception circuit 131 of the provider institution client application 125.

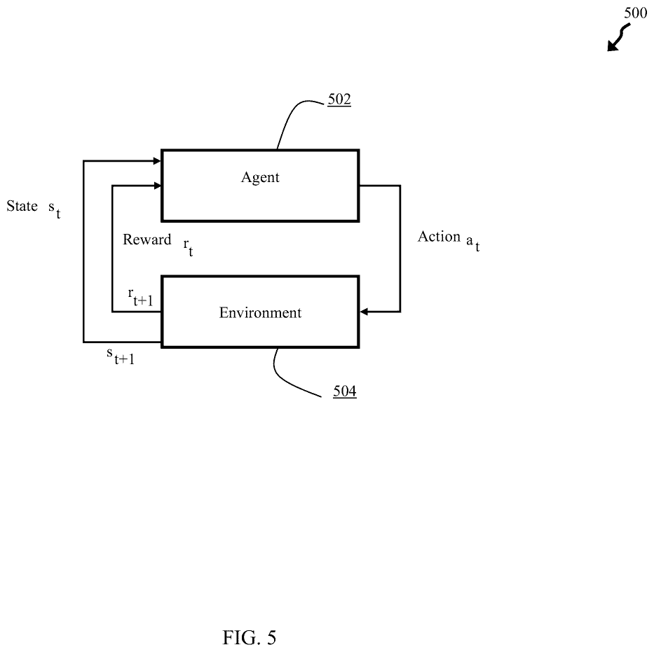

In some configurations, the obligation circuit 103 may determine proposed obligations for the agreement. The “obligations” refer to a term of the account that defines one or more obligations under the agreement while the prompt refers to a communication provided to the user device (e.g., a question, a statement, etc.) that may include the determined proposed obligation. In one embodiment, the proposed obligations are communicated to the user via the interactive communication session and are determined using constrained optimization techniques. In other configurations, the obligation circuit 103 may use reinforcement learning (as described with reference to FIG. 5) to identify or select obligations. For example, if the obligation circuit 103 is employed to modify an existing obligation, the obligation circuit 103 may determine the severity of the modification (e.g., how much to decrease a current required payment amount), the number of obligations to modify (e.g., the payment amount and the interest rate amount, just the interest rate amount, etc.), and/or specific terms to modify. In operation and in some embodiments, the obligation circuit 103 may use reinforcement learning to generate one or more obligations for a new agreement associated with the user account. In any event, the obligation circuit 103 may generate proposed terms the same way (and determined the same term) for any user 120 given the same or similar extracted user response data. Thus, the prompt circuit 105 and/or the obligation circuit 103 may use the machine learning circuit 111 to select, identify, determine, or generate a prompt and/or obligation. Referring now to FIG. 5, a simplified reinforcement learning model 500 is shown, according to an embodiment. The simplified reinforcement learning model may be used to determine a true confidence of a user during an interactive communication session. The simplified reinforcement learning model that may be used to determine prompts to provide to a user during an interactive communication session. Reinforcement learning is a method of training a machine learning model using agents selecting actions to maximize rewards based on a policy network. The machine learning circuit 111 may be configured to execute one or more reinforcement learning models.

In reinforcement learning, an agent 502 interacts with an environment 504 to train a policy that is used to select prompts (including, for example, proposed obligations) to be communicated to the user device 121 as part of the interactive communication session. As used herein, the “agent” 502 refers to an algorithm (e.g., formula, process, etc.) that is executed by the processor 119 to learn or train a policy directed to selecting an action. Asynchronous advantage actor critic reinforcement learning is an example of reinforcement learning that may be performed using processor 119 to instantiate multiple learning agents 502 in parallel. The agents 502, as described herein, learn to select prompts to be communicated to the user device 121 based on the policy trained over time. Each agent 502 asynchronously performs actions and calculates or determines rewards using a single machine learning model (such as a deep neural network) and/or a global model.

In one embodiment, the environment 504 refers to the state of the user 120 confidence. Thus, the environment 504 may indicate a state representing the user's confidence in their ability to satisfy one or more proposed obligations. At each time step t (e.g., each iteration), the agent 502 observes a state sₜ of the environment 504 and selects an action from a set of actions. The possible set of actions (e.g., action space) for a reinforcement learning model called to select a prompt for the prompt circuit 105 may include selecting an information query, selecting a probing query, selecting a recommendation query, not selecting a next query, and the like.

The action space for a reinforcement learning model called to identify an obligation, revise an obligation, and/or generate an obligation for the obligation circuit 103 may be arbitrarily defined and depend on predefined solution space considerations. For example, the solution space may be discretized such that the modifications to the terms of the agreement are at fixed intervals rather than on a continuous range. The action space may also include more complex schemes such as dual step-sizes for an explore/exploit approach.

In other examples, the action space may be continuous rather than discrete. For example, the action space of the obligation circuit 103 may include such actions, such as “modify the payment term”, “modify the payment duration term”, “do not modify the payment term”, and the like. In the event that a continuous solution space is implemented, the agents 502 may need to train for a longer duration of time such that the agents 502 can determine, for example, how much to modify an obligation (e.g., how much to reduce an existing payment amount) and which obligations to modify (e.g., making minor adjustments to the obligation versus making significant adjustments to the obligation).

In a non-limiting example, a user 120 may have an existing agreement with a provider institution. An obligation of the agreement may include making monthly payments of a predetermined amount. In the example, the user 120 may initiate a communication with the provider institution computing system 110 because the user 120 may wish to modify an obligation in the existing agreement due to experiencing a hardship and provide such notification via the client application 125. The user 120 may indicate, via the client application 125 and the interactive communication session, that he/she is comfortable with a particular obligation, such as a particular payment amount. In turn, the obligation circuit 103 may propose a modified obligation based on the user's indication which may ultimately adjust the existing agreement to reflect this modified obligation. In turn, the user may be able to meet the conditions of their agreement in a way that was previously unlikely.

The obligation circuit 103 may modify the obligation based on the expected time (duration) associated with the hardship indicated in the user response. Beneficially, the provider institution computing system 110 then recognizes short term and long term expected financial hardships. If the time associated with the hardship does not exceed a predefined threshold (e.g., a time threshold determined by an administrator or agent of the provider institution computing system corresponding with an expected “short-term” duration hardship), the obligation circuit 103 may determine a first type of obligation response that coincides with a flat obligation term. If the time associated with the hardship exceeds the threshold (corresponding with a predefined “long-term” hardship duration0, the obligation circuit 103 may determine a second type of obligation that coincides with a step-up obligation. In this way, the second type of obligation corresponds with hardships that are expected to be relatively longer in duration than the first type of obligation. For example, if the user 120 indicates that they are facing a hardship that will last a predefined short duration of time (e.g., eight months, ten months, or some other relatively short period of time), the obligation circuit 103 may propose the first obligation type (e.g., a reduced monthly payment amount of X relative to an existing amount of Y). If the user 120 communicates that the hardship will be or is expected to be greater than the predefined short duration of time (e.g., greater than twenty-four months, such as 50 months), the obligation circuit 103 may determine and propose the second obligation type (e.g., the step-up obligation). As discussed herein, the obligation circuit 103 may determine and propose terms of an agreement using a variety of processes such as reinforcement learning or other one or more algorithms.

In a non-limiting example, a user 120 may make monthly payments of a predefined amount (e.g., $108.00) according to an existing agreement. The machine learning circuit 111 and/or the confidence determination circuit 109 may determine, based on a user response to a query, that the user 120 is comfortable paying less than a second predefined amount (e.g., $45/month). The obligation circuit 103 may propose a new monthly payment term based on an expected duration of the hardship (a numerical value extracted from a user response, e.g., six months, 60 months, etc.) and their comfortability with paying less than the second predefined amount. For example, if the user 120 believes that the hardship will last eight months, the obligation circuit 103 may propose that the user pay $43.33/month for eight months (reduced from the standing $108.00 monthly payments and considering the user's request of paying less than $45/month). If the user 120 believes that the hardship will last 50 months (a long-term duration hardship), the obligation circuit 103 may propose a step-up obligation. For example, the obligation circuit 103 may propose that the user 120 pay $35/month for the first 1-18 months and step up to $91.96 for the second 19-50 months. In the step-up scenario, the monthly payment amounts may vary at various times in order to accommodate the user's likely improvement in financial situation (i.e., vary upwards over time). Thus, the obligations defined by the agreement may be adjusted based on an expected hardship duration time, which may make the interactive communication session more personable.

Continuing with the example, the prompt circuit 105 may select a question that evaluates the user's 120 comfort/confidence with the proposed term revisions (i.e., obligation modifications). If the user 120 indicates that the step up from a first amount to a second amount (e.g., $35/month to $91.96 in the above example) is too large, the obligation circuit 103 may propose a third type of obligation that corresponds with a multi-step up approach. For example, the obligation circuit 103 may propose paying a first amount (e.g., $35) for the first 1-18 months, a second greater amount than the first amount (e.g., $58.23) for the second 19-25 months, a third amount greater than the second amount (e.g., $79.63) for the third 25-30 months, and a fourth amount greater than the third amount (e.g., $66.60) for the last 31-50 months. Thus, the provider institution computing system 110 is collaborating with the user to revise obligations of their agreement to accommodate their expected hardship duration and assist the user with continuing to meet their obligations, albeit that the obligations are modified relative to an initial or original obligation (e.g., a reduced required monthly payment amount relative to an initial payment amount).

Referring still to FIG. 5, agents 502 may select an action (e.g., a specific obligation if the reinforcement learning model 500 is called by the obligation circuit 103 or a query if the reinforcement learning model 500 is called by the prompt circuit 105) based on the value of taking each action, where the value of selecting the action is defined as the expected reward received when taking that action from the possible set of actions. Agents 502 may select actions based on exploratory actions and exploitation actions. An exploratory action improves an agent's knowledge about an action by using the explored action in a sequence resulting in a reward calculation. The exploratory action may be an action unrestricted by prior knowledge. An exploitation action is a “greedy” action that exploits the agent's 502 current action-value estimates. Using epsilon-greedy action selection, for example, the agent 502 balances exploratory actions and exploitation actions. The agent 502 may randomly select an epsilon value and/or select the epsilon value from a predetermined distribution of epsilon values. Based on a selected epsilon value and one or more exploitation and/or exploration thresholds, the agent 502 may perform an exploitation action or an exploratory action. In some arrangements, the epsilon distribution and/or an exploratory action threshold/exploitation action threshold may vary over time.

Agents 502 may also select an action (e.g., a specific obligation if the reinforcement learning model 500 is called by the obligation circuit 103 and/or a query (which may include an obligation) if the reinforcement learning model 500 is called by the prompt circuit 105) using a policy, where the policy maps states of the environment to actions. The policy gives the probability of taking a certain action when the agent 502 is in a certain state.

In response to selecting an action (or multiple actions), the environment 504 may change, and there may be a new user confidence state (e.g., a new state sₜ₊₁). The agent 502 may receive and/or determine feedback indicating how the action affected the environment 504. For example, the action resulting in a selected query and/or obligation may result in the user 120 being more or less confident such that the environment 504 changes.

The agent 502 learns (e.g., reconfigures its policy) by taking actions and analyzing the rewards received in response to the changed environment 504. A reward function can include, for example, R(sₜ), R(sₜ, aₜ), and R(sₜ, aₜ, sₜ₊₁). In some configurations, if the reinforcement learning model 500 is called by the prompt circuit 105, the reward may be a query selecting a goodness function. For example, a reward function based on a query selection goodness function may include various quadratic terms representing considerations determined by an agent (or administrator) of the provider institution that would select a query for the user 120 given the user's confidence. If the reinforcement learning model 500 is called by the obligation circuit 103, the reward function may valuate the difference between the obligation selected by the agents 502 and an obligation selected by a real agent (e.g., an obligation historically selected by an agent of the provider institution), an average obligation selected by real agents, and/or an average obligation of users. For example, the average obligation of users may include historical obligations of a population of similarly situated users. Specifically, reward functions that may valuate the difference between the obligation selected by the agents 502 and an obligation selected by a real agent may include the root mean square error function, square error function, absolute error function, and the like.

Each iteration (or after multiple iterations and/or steps), the agent 502 selects a policy (and an action) based on the current state sₜ and the agent 502 calculates a reward. Each iteration, the agent 502 iteratively increases a summation of rewards. At each step (or series of steps), policies may be weighted based on the rewards determined such that certain policies (and actions) are encouraged and/or discouraged in response to the environment 504 being in a certain state (e.g., the user's confidence changing). Weights may be determined to maximize the objective function (e.g., reward function) during training. The aim of training is to train the reinforcement learning model, or an agent 502 of the reinforcement learning model, to optimize a policy such that selected obligations and/or queries will result in a user confidence value being at or above a predefined threshold thereby providing a relatively high likelihood that the user may be able to satisfy one or more revised or modified obligations. Training may involve optimizing policies by taking the gradient of an objective function (e.g., the reward function) to maximize a cumulative sum of rewards based on encouraging actions (e.g., selected queries and/or obligations) that will result in a high user confidence score (or improve the user's confidence score) associated with the selected query and/or obligation, at each step, or after a predetermined number of steps (e.g., a delayed reward).

In some configurations, the rewards at each step may be compared (e.g., on an iterative basis) to a baseline. The baseline may be an expected performance. For example, the expected performance may be a historic confidence score associated with an obligation and prompt/reply by a user. For instance, a historic confidence score may be a historic confidence score associated with a previous user based on the previous user's response to the same/similar proposed obligation query (e.g., a similar periodic payment obligation modification). Evaluating a difference between the baseline and the reward is considered evaluating a value of advantage (or advantage value). The value of the advantage indicates how much better the reward is from the baseline (e.g., instead of an indication of which actions were rewarded and which actions were penalized).

The agents 502 train themselves by choosing the action(s) based on policies that provide the highest cumulative set of rewards, where the highest rewards are associated with actions that result in high user confidence values. The agents 502 of the machine learning model may continue training until a predetermined threshold has been satisfied. For instance, the analytics server may train the machine learning model until the advantage value is within a predetermined accuracy threshold. The machine learning model may also be trained until a predetermined number of steps (or series of steps called episodes, or iterations) have been reached.

In some configurations, policies that are trained to result in high user confidences (or improved user confidences) may be updated every step (or predetermined number of steps) based on the cumulative rewards determined by each agent 502. Each agent 502 may contribute to the global policy such that the total knowledge of the global model increases and the global policy learns how to best modify the query/prompt selection and/or obligation/term selection. Each time the global model is updated (e.g., after every step and/or predetermined number of steps), new weights are propagated back to agents 502 such that each agent 502 shares common policies.

The global model allows each agent 502 to have a more diversified training data and eliminates a need for synchronization of models associated with each agent 502. In other configurations, there may be models associated with each agent 502 and each agent 502 may calculate a reward using a corresponding machine learning model. In some embodiments, agents 502 in other servers may update the global model (e.g., federated learning).

Once trained and validated, the agents 502 may be employed during testing (or an inference phase). During testing, the machine learning model (and in particular, the agents 502) may ingest unknown data to predict questions (or prompts, queries) to be selected by the prompt circuit 105 or obligation terms to be selected by the obligation circuit 103.

While the immediately previous paragraphs described an example machine learning implementation to assess user confidence and/or prompts for the interactive communication session, additional components of the interactive communication platform computing system 100 are also shown that are described herein below.

Accordingly, referring back to FIG. 1, the provider institution computing system 110 may include an optical character recognition (OCR) circuit 117. The OCR circuit 117 may include computer-executable instructions structured to extract information from text entered by a user 120 and received by the reception circuit 104 during the interactive communication session. The OCR circuit 117 may be used to recognize characters in an image. For example, the image objects, or clusters of related pixels in the image, may be compared to characters in a character and/or font database. The OCR circuit 117 may match the image objects in the document to characteristics of characters. For example, an image object may comprise part of a curve that resembles the curve in the lower portion of the letter ‘c’. The OCR circuit 117 may compare the curve with curves in other characters via a database. The OCR circuit 117 may predict the character based on related image objects and characteristics of related image objects in the database. For example, after comparing image objects in a character database, the OCR circuit 117 may determine that the character is a ‘c’. The OCR circuit 117 may also classify words based on an image. The OCR circuit 117 may utilize a dictionary to verify the predicted words extracted from the document (e.g., the user may write “yes” on a piece of paper in response to a prompt during the session which is captured by a camera on the user device and transmitted back to the OCR circuit 117 for analysis). In a simple example, the OCR circuit 117 may determine a string of characters extracted from the document to be “dat”. The OCR circuit 117 may check the predicted string of characters “dat” and determine that the string “dat” should be corrected with “cat” based on the curves of characters. In some embodiments, other object detection circuits may be employed by the provider institution circuit 115 in addition to, or instead of the OCR circuit 117.

The natural language processing (NLP) circuit 108 may include computer-executable instructions structured to extract information from audio from a user 120. For example, the NLP circuit 108 may analyze audio data received from the reception circuit 104. A user 120 using the user device 121 may respond to a prompt received by the reception circuit 131 audibly. The response circuit 130 may capture an audio user response using a microphone of the user device 121. The audio response may be communicated to the provider institution circuit 115 via network 101 and received by the reception circuit 104. Subsequently, the NLP circuit 108 may extract information from the audio response. The NLP circuit 108 may parse the audio signal into audio frames containing portions of audio data. The frames may be portions or segments of the audio signal having a fixed length across the time series, where the length of the frames may be pre-established or dynamically determined.

The NLP circuit 108 may also transform the audio data into a different representation during processing. The NLP circuit 108 initially generates and represents the audio signal and frames (and optionally sub-frames) according to a time domain. The NLP circuit 108 transforms the frames (initially in the time domain) to a frequency domain or spectrogram representation, representing the energy associated with the frequency components of the audio signal in each of the frames, thereby generating a transformed representation. In some implementations, the NLP circuit 108 executes a Fast-Fourier Transform (FFT) operation of the frames to transform the audio data in the time domain to the frequency domain. For each frame (or sub-frame), the NLP circuit 108 may perform a simple scaling operation so that the frame occupies the range a predetermined range of measurable energy.

In some implementations, the NLP circuit 108 may employ a scaling function to accentuate aspects of the speech spectrum (e.g., spectrogram representation). The speech spectrum, and in particular the voiced speech, will decay at higher frequencies. The scaling function beneficially accentuates the voiced speech such that the voice speech is differentiated from background noise in the audio signal. The NLP circuit 108 may perform an exponentiation operation on the array resulting from the FFT transformation. The NLP circuit 108 may employ automatic speech recognition and/or natural language processing algorithms to interpret the audio signal.

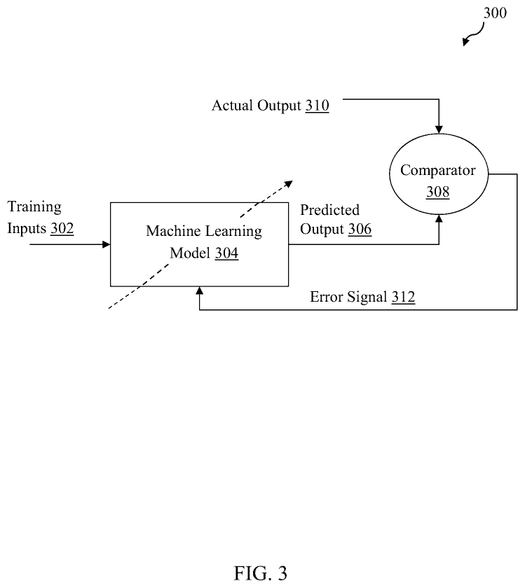

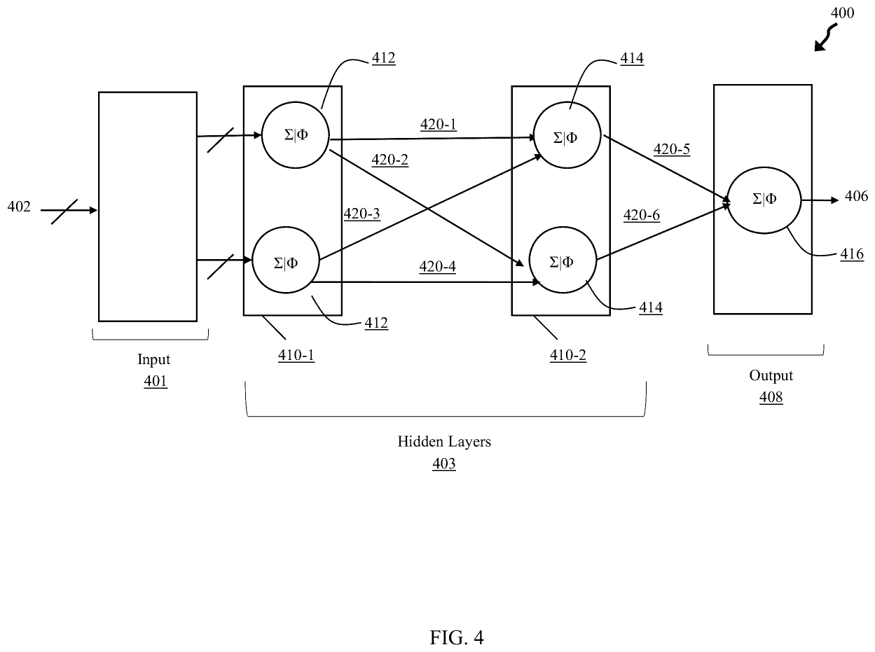

The machine learning circuit 111 may include computer-executable instructions structured to execute various machine learning models such as neural networks including convolutional neural networks, long short term memory networks, gated networks, deep neural networks), support vector machines (SVMs), random forests, and the like. The machine learning models in the machine learning circuit 111 may be trained to generate a confidence score or value in response to a user input (e.g., audio user inputs, text user inputs, graphical/visual user inputs, etc., some combination thereof, and so on). The machine learning models may ingest characteristics of user inputs, extract features associated with the ingested data, and analyze the ingested data using a trained machine learning model to predict or otherwise determine a confidence value. In some arrangements, the machine learning circuit 111 may execute the same or similar operations as the NLP circuit 108 (e.g., parse an audio signal, transform the audio signal into a different domain (e.g., time domain to frequency domain), scale an audio signal, and the like). The machine learning models in the machine learning circuit 111 are discussed further herein with reference to FIGS. 3 and 4.

The confidence determination circuit 109 is configured to determine a confidence associated with a user input (or user response) received by the reception circuit 104 of the provider institution computing system 110 in response to a prompt/obligation received by the reception circuit 131 of the user device 121. The “confidence” (or, confidence value, score, indicator, etc.) refers to a determined belief in the user's conviction to satisfy one or more proposed obligations. The confidence determination circuit 109 evaluates the confidence associated with the user response to a prompt to determine whether the user 120 is truly confident in their ability to satisfy a term in the prompt transmitted to the user (i.e., does the confidence determination circuit 109 believe that the user 120 has high, medium, or low confidence when the user 120 says that he/she can satisfy a proposed obligation). In operation, the confidence determination circuit 109 determines a true confidence relative to a confidence threshold. Thus, the confidence determination circuit 109 may use a received user confidence to determine a true confidence value that is subsequently compared to a confidence threshold to determine or assess the likelihood of the user to satisfy one or more revised/updated payment obligations. In this regard, the true confidence refers to the confidence used to compare to the predefined confidence threshold. In some embodiments, the received user confidence is the true confidence. In other embodiments, the confidence associated with the user input is analyzed to determine the true confidence (e.g., the user 120 may be exaggerating the user's 120 confidence). The confidence determination circuit 109 may include a setting that is actuable by an attendant to implement deeper analyses of the received confidence to determine a true confidence. Thus, a default operation setting may be that the user's confidence is automatically designated as the true confidence via the confidence determination circuit 109.

Referring to the first scenario, in this embodiment, the confidence determination circuit 109 determines a true confidence value based on an explicit user input. In these embodiments, when the user input explicitly indicates a confidence value, the confidence determination circuit 109 may determine that the true confidence is the same as the explicit user input. As an example, the user may provide an indication of their confidence (e.g., a quantitative value (e.g., 0-10, a percentage such as sixty-percent confident, etc.) and/or a qualitative value (e.g., “I'm reasonably confident that I can meet the new payment obligation.”). Here, the confidence determination circuit 109 assigns this confidence indication as the true confidence, thereby completely relying on the user's input without looking to other factors. For example, the explicit user input may be in the form of a rating using a rating scale (e.g., a Likert scale or other rating scale). The scale may range from a first value to a second value (e.g., 1-5) where the first value is lower than the second value. Accordingly, a user input of a value closer to the first value (e.g., a 1 on the 1-5 scale) represents that the user 120 is not confident at all, and a user input of value closer to the second value (e.g., a 5 on the 1-5 scale) represents that the user 120 is confident. Here, the user may provide a confidence input of a value (e.g., “3” on the scale above). The confidence determination circuit 109 may then define this value as the true confidence of the user. As another example, the user may provide a qualitative answer which is then used by the confidence determination circuit 109 as the true confidence (e.g., “I'm reasonably confident.” may be designated as medium confidence). Here, words may be mapped (e.g., via a look-up table or other mapping program/process) to confidence levels for qualitative answers (e.g., “reasonable” is equated to medium, “unsure” is equated to low, “no doubt” is equated to high, etc.).

Thus, in these embodiments, the true confidence may be based on a complete reliance on the explicit user input.

In other embodiments and referring to the second scenario where the user's confidence is analyzed to determine a true confidence (which may be the same or different than the user's provided confidence), one or more circuits may check or otherwise assess the explicit user input based on characteristics of the user response or other factors. For example, the user 120 may indicate that they are very confident, but the characteristics of their response (such as typing a response and deleting it or a very delayed response) may indicate that the explicit user input may be exaggerated. Accordingly, the user responses (audio, graphic, and/or text responses) may be analyzed using one or more circuits (such as the machine learning circuit 111, the NLP circuit 108, and/or the OCR circuit 117) to determine the true confidence in this scenario. In other embodiments, the confidence determination circuit 109 may determine the true confidence of the user input by comparing characteristics of the user's situation relative to a population of other users (e.g., other similarly situated users). In yet other embodiments, the confidence determination circuit 109 may determine the true confidence of the user input by evaluating the full or nearly full financial picture of the user 120. In yet other embodiments, any combination of factors may be used to determine a true confidence (e.g., analyze the user response itself, examine the user response relative to other user replies, analyze the user response relative to the user's financial situation).

The confidence determination circuit 109 may determine the population of similarly situated users by identifying, tracking and storing historic prompts and associated user responses from a plurality of historic interactive communication sessions. If the historic user provided authorization to monitor the historic user, the confidence determination circuit 109 may monitor one or more user accounts to determine whether the historic user was able to meet the revised obligations (e.g., after saying they had high confidence that they could meet the revised obligations) and track this information. The confidence determination circuit 109 may determine that the historic user was able to meet the revised obligations if the user acted according to the revised obligations (e.g., successfully pays a reduced monthly payment in response to a revised obligation). The confidence determination circuit 109 may store the historic user replies/historic user characteristics to the prompts (and whether the historic user was able to meet the revised obligations) in memory 116. As an example, the user may provide a qualitative or quantitative response to a proposed payment obligation (e.g., ninety-percent confident). The confidence determination circuit 109 may examine similarly situated users who provided a similar response and what subsequently happened to those users (e.g., only forty-percent actually followed through on the revised payment obligation despite providing a ninety-percent confidence input). The confidence determination circuit 109 may determine the true confidence to be the amount of similarly situated users that actually followed through on the revised obligation (e.g., fifty percent). In this situation, the true confidence value differs from that of the received confidence value (e.g., fifty percent versus ninety percent). The confidence determination circuit 109 may create the population of similarly situated users by categorizing the historic data by grouping and identifying similar hardships between historic users. For example, the confidence determination circuit 109 may use sequential clustering algorithms (e.g., k-means clustering) or may call the machine learning circuit 111 to executing sequential clustering algorithms. The confidence determination circuit 109 may also group similarly situated users using groups manually determined by an operator of the provider institution computing system 110.

In another example, the provider institution computing system 110 may monitor the user's income and other sources of wealth that are linked to the user account to determine the full or nearly fully financial picture of the user 120. In some embodiments, before the provider institution computing system 110 monitors the user's other accounts, the provider institution computing system 110 may receive authorization to monitor the one or more user accounts (e.g., other sources of wealth that are linked to the user account) from the user 120. The confidence determination circuit 109 may increase of decrease the confidence score to determine a true confidence score based on information extracted from the monitored user accounts. For example, the confidence determination circuit 109 may compare a sum of the user's wealth (determined by monitoring other user accounts and summing the wealth in the other user accounts) to a proposed payment obligation to increase or decrease the confidence score determined from the user response. For example, the user may provide a qualitative input to a proposed payment obligation of: “Yes, I think I can meet that new payment obligation amount.” The confidence determination circuit 109 may normally equate “think” with a medium confidence value (i.e., the true confidence value is a medium amount). However, here, the confidence determination circuit examines the user's other linked account to determine that the user is receiving twice-a-month payments that each exceed the proposed payment obligation amount. In this case, the confidence determination circuit 109 upgrades the received/determined confidence (i.e., the medium amount) to a high confidence (the true confidence is a high confidence amount).

In each of the aforementioned scenarios, the confidence determination circuit 109 evaluates the user confidence from the user input by comparing the true confidence to a predetermined confidence threshold. The confidence threshold may be determined by an operator, administrator or agent of the provider institution computing system 110. The confidence threshold may be a qualitative and/or quantitative value and, in operation, correspond with the format of the true confidence. For example, the confidence threshold may be a numerical value (e.g., 60 on a scale of 0-100) and/or a qualitative value (e.g., medium on a scale of low, medium, and high). The confidence threshold format may be recalled/retrieved by the confidence determination circuit 109 in response to the true confidence. For example, if a user provides a numerical confidence value (e.g., seventy-five percent confident), then the confidence determination circuit may retrieve a threshold that is specific to this value (e.g., eighty-percent). This enables a comparison to be effectively done by the confidence determination circuit 109.

In the event the true confidence satisfies the confidence threshold (i.e., meets or exceeds), the confidence determination circuit 109 may determine that the user is confident in being able to satisfy or meet the proposed obligations in the prompt previously transmitted to the user 120. In the event the true confidence does not satisfy the confidence threshold, the confidence determination circuit 109 may determine that the user 120 is not confident in being able to satisfy or meet the proposed obligations and, responsively, revises one or more obligation terms of the account (e.g., continues to iteratively revise a new payment amount).

In an illustrative example, the user 120 may provide an audible input where the NLP circuit 108 determines a confidence value from the audible input prompted via the provider institution circuit 115 (and specifically the prompt circuit 105). For example, the user 120 may say: “I am 99% confident that I can meet the modified payment obligation for this account.” The NLP circuit 108 may extract information (e.g., 99) from the audio signal and feed the extracted information to the confidence determination circuit 109. In which case, the confidence determination circuit 109 may determine that the received confidence value (e.g., 99% confident) is the true confidence value and compare it to a confidence threshold (e.g., 75%) to determine if additional modifications should be performed relative to the proposed payment obligations (i.e., because the confidence is above the threshold, additional term modification is unnecessary which thereby saves computing resources). In contrast, the NLP circuit may identify a hesitancy present in the audible input (i.e., a speech event, such as a hesitancy or tremble, in the voice may be identified to determine a true confidence value). For example, frames containing speech data in the parsed audible signal may be detected to satisfy a threshold time duration, identifying that the user 120 was hesitant in their response. For example, the user may speak in one frame, and the next frame with speech may be two seconds later. The confidence determination circuit 109 may determine that the true confidence is less than the confidence articulated during the audible input.

In another illustrative example, the user 120 may provide an indication via the client application 125 that he/she has a high confidence in meeting a new payment amount. However, the confidence determination circuit 109 examines a predefined population of similar situations to determine that this payment amount was only met less than predefined amount of time (e.g., less than fifty percent). In turn and rather than accepting the user 120 at their word, the prompt circuit 105 may generate a follow-up prompt (e.g., “Thank you for your confidence in believing to meet this new amount. However, we have found that users similarly situated to you have only been able to hit this amount less than fifty percent of the time. Would you like a different proposed payment amount?”). Thus, the confidence determination circuit 109 compares the confidence associated with the user's belief to a confidence threshold based on similarly situated users to determines the true confidence amount of the user as being less than the original high confidence amount expressed by the user. Subsequently, the provider institution computing system 110 determines updated payment obligation terms.

As another example, the machine learning circuit 111 may determine a true confidence value from a text and/or audio and/or audio/visual user input and feed the confidence score to the confidence determination circuit 109 to evaluate the user response. For example, as described with reference to FIG. 3, the machine learning circuit 111 may be trained to evaluate characteristics (or features) of the user input including how fast the user 120 responded (e.g., typed in an answer, spoke an answer), the duration of the user response (e.g., did the user 120 type an input, delete it, then type an input again? Did the user 120 ramble over the phone?), and whether the user 120 used contractions, for example. As discussed herein, the machine learning models in the machine learning circuit 111 may be trained to generate a true confidence score in response to the user input (and characteristics/features of the user input, the full financial picture of the user, and the characteristics/features of the user's situation relative to the population of similarly situated users). Accordingly, the confidence determination circuit 109 may compare the determined true confidence to the confidence threshold to determine whether additional agreement terms should be revised to address the user's financial hardship.

In some configurations, the machine learning models in the machine learning circuit 111 may be trained to predict a true confidence score using supervised learning. Various examples are described herein with respect to Figures. The confidence score determination processes may be used to evaluate the user's response to determine whether to iteratively continue with adjustment of one or more obligation terms (e.g., payment amounts).

Referring first to FIG. 3, a block diagram of an example system 300 using supervised learning that may be used to determine a true confidence of a user during an interactive communication session, is shown according to an example embodiment. Supervised learning is a method of training a machine learning model given input-output pairs. An input-output pair is an input with an associated known output (e.g., an expected output). Machine learning model 304 may be trained on known input-output pairs (e.g., historic user response, characteristic inputs, other user account information and characteristics relative to a population of similarly situated users and associated historic true confidence scores) such that the machine learning model 304 can learn how to predict known outputs given known inputs. Once a machine learning model 304 has learned how to predict known input-output pairs, the machine learning model 304 can operate on unknown inputs to predict an output. The machine learning circuit 111 may employ one or more machine learning models 304. To train the machine learning models to generate a confidence score using supervised learning, training inputs 302 and actual outputs 310 may be provided to the machine learning model 304. Training inputs 302 may include historic user inputs (e.g., audio data and/or text data in response to queries during historic interactive communication sessions with other users), characteristics of the historic user inputs, historic other user account information and characteristics relative to a population of similarly situated users. For example, characteristics of historic user inputs may include how fast the user 120 responded (e.g., typed in an answer, spoke an answer), the duration of the user response (e.g., did the user 120 type an input, delete it, then type an input again? Did the user 120 ramble over the phone? How long did the user 120 hold the DTMF tone?), whether the user 120 used contractions, and the like. Examples of other user account information may be information helpful in understanding the full financial situation of the user. For example, other user account information may include the user's other sources of wealth. Examples of characteristics relative to a population of similarly situated users includes characteristics of the user 120 similar to characteristics of historic users, including historic true confidences, historic user inputs, and historic user responses. Actual outputs 310 may include user confidences associated with the historic interactive communication session. For example, actual outputs may be historic actual true user confidences determined the provider institution computing system 110, provided by a user 120 at the time of the user input during the interactive communication session, determined to be a true confidence score as a result of tracking the user accounts over time, or determined by the confidence determination circuit 109. The inputs 302 and actual outputs 310 may be stored in memory 116. For example, memory 116 of the provider institution computing system 110 may store historic user inputs and confidence scores. These inputs/outputs may be used to determine a true confidence value from the user's provided confidence value.

In an example, a machine learning model 304 may use the training inputs 302 (e.g., characteristics of historic user inputs, user inputs, other user account information, and/or characteristics relative to a population of similarly situated users) to predict outputs 306 (e.g., a predicted confidence score), by applying the current state of the machine learning model 304 to the training inputs 302. The comparator 308 may compare the predicted outputs 306 to the actual outputs 310 (e.g., a true confidence score determined as a result of tracking the user account) to determine an amount of error or differences.

The error (represented by error signal 312) determined by the comparator 308 may be used to adjust the weights in the machine learning model 304 such that the machine learning model 304 changes (or learns) over time to generate a relatively accurate true confidence score using the input-output pairs. The machine learning model 304 may be trained using the backpropagation algorithm, for instance. The backpropagation algorithm operates by propagating the error signal 312. The error signal 312 may be calculated each iteration (e.g., each pair of training inputs 302 and associated actual outputs 310), batch, and/or epoch and propagated through all of the algorithmic weights in the machine learning model 304 such that the algorithmic weights adapt based on the amount of error. The error is minimized using a loss function. Non-limiting examples of loss functions may include the square error function, the room mean square error function, and/or the cross entropy error function.

The weighting coefficients of the machine learning model 304 may be tuned to reduce the amount of error thereby minimizing the differences between (or otherwise converging) the predicted output 306 and the actual output 310 such that the predicted confidence score is similar to the true confidence score. The machine learning model 304 may be trained until the error determined at the comparator 308 is within a certain threshold (or a threshold number of batches, epochs, or iterations have been reached). The trained machine learning model 304 and associated weighting coefficients may subsequently be stored in memory 116 or other data repository (e.g., a database) such that the machine learning model 304 may be employed on unknown data (e.g., not training inputs 302). Once trained and validated, the machine learning model 304 may be employed during testing (or an inference phase). During testing, the machine learning model 304 may ingest unknown data to predict confidence scores.

Referring next to FIG. 4, a block diagram of a simplified neural network model 400 is shown, according to an example embodiment. The neural network may be a machine learning model that is trained to generate a true confidence value based on a user input, characteristics of the user input, historic other user account information and characteristics relative to a population of similarly situated users. The neural network model 400 may include a stack of distinct layers (vertically oriented) that transform a variable number of inputs 402 being ingested by an input layer 404, into an output 406 at the output layer 408.

The neural network model 400 may include a number of hidden layers 410 between the input layer 404 and output layer 408. Each hidden layer has a respective number of nodes (412, 414 and 416). In the neural network model 400, the first hidden layer 410-1 has nodes 412, and the second hidden layer 410-2 has nodes 414. The nodes 412 and 414 perform a particular computation and are interconnected to the nodes of adjacent layers (e.g., nodes 412 in the first hidden layer 410-1 are connected to nodes 414 in a second hidden layer 410-2, and nodes 414 in the second hidden layer 410-2 are connected to nodes 416 in the output layer 408). Each of the nodes (412, 414 and 416) sum up the values from adjacent nodes and apply an activation function, allowing the neural network model 400 to detect nonlinear patterns in the inputs 402. Each of the nodes (412, 414 and 416) are interconnected by weights 420-1, 420-2, 420-3, 420-4, 420-5, 420-6 (collectively referred to as weights 420). Weights 420 are tuned during training to adjust the strength of the node. The adjustment of the strength of the node facilitates the neural network's ability to predict an accurate output 406.

Referring back to FIG. 1, in some arrangements, the provider institution computing system 110 may access the machine learning circuit 111 using an API (e.g., from the API gateway 113). Beneficially, the provider institution computing system 110 may reduce the computing resources consumed by the provider institution by executing one or more operations using the API. For example, each machine learning model of the machine learning circuit 111 may have an associated API that may be used to call the machine learning model to reduce the burdens/computational resources of operating the machine learning models on the provider institution computing system 110. For example, APIs may be invoked such that the machine learning models are implemented in different environments such as on cloud environments.

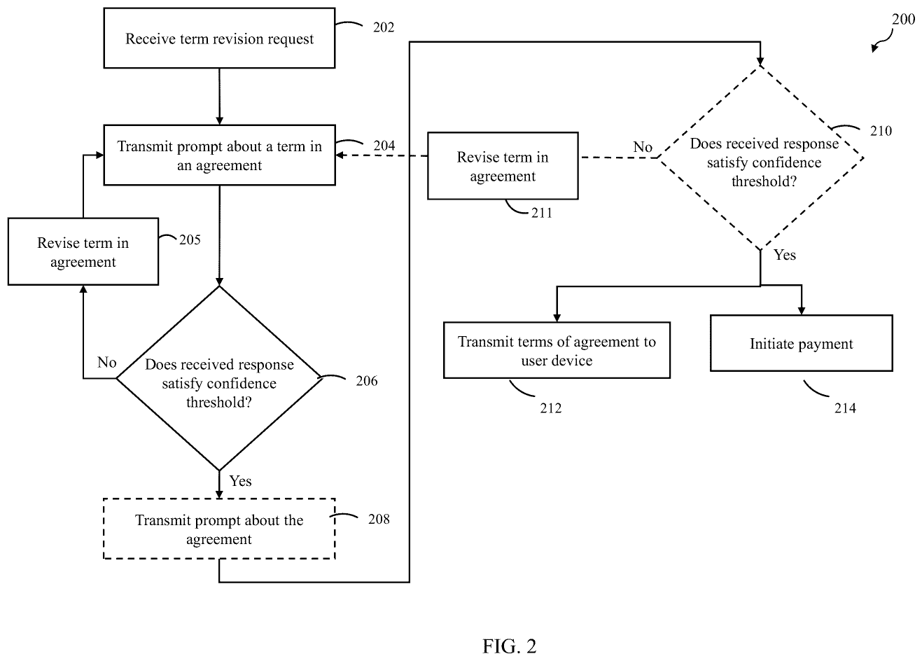

Referring now to FIG. 2, a flow diagram of method 200 for revising account obligations (e.g., account terms) is shown, according to an example embodiment. A user 120 may have an account managed by the provider institution. The account may be associated with an agreement that defines a payment obligation such as a loan (e.g., mortgage, vehicle loan, etc.). Terms of the agreement may include a minimum payment amount, a payment due frequency (e.g., monthly, bi-monthly, etc.), a term of the payment obligation, a time frame, a minimum payment amount, an interest rate, whether prepayment is allowed, and so on. Accordingly and as described herein, the account may be a loan account or any other account that has a payment obligation. In the example of FIG. 2, the user 120 may be or is going to experience a hardship in meeting or satisfying one or more terms of the account (e.g., an inability to meet their payment obligations, etc.).

One goal for revising an account term (and obligation) is to increase a user's ability to satisfy the agreement (e.g., make payments). Method 200 is an iterative, user-centric process to increase user confidence in their ability to meet or satisfy an updated term (e.g., a reduced payment obligation for a determined period of time). Another goal for revising an account term is to reduce and/or mitigate penalties resulting from a user's inability to satisfy an account term thereby preserving the user's reputation (e.g., credit score). Technically and beneficially, the method 200 may reduce current or expected computational resources and traffic transmitted over a network. A user 120 who has adjusted the terms of their account in response to experiencing a hardship in meeting or satisfying one or more account terms (such as the terms associated with a payment obligation) reduces network traffic by minimizing current or expected reminders transmitted to the user 120. For example, reminders may not need to be transmitted to the user 120, reminding the user 120 of the troubled account and/or requesting the user 120 take an action associated with their account (e.g., to make a payment). Accordingly, computational resources are conserved by the provider institution computing system 110 by not continuously generating reminders to transmit to the user 120. Similarly, computational resources are conserved by the user device 121 by not receiving and processing reminders from the provider institution computing system 110. Instead, method 200 provides a discrete computing session may minimize overall computer resource consumption (e.g., processing and generating of reminders, storing of reminders, printing and physically mailing of reminders may be reduced or avoided, etc.).

In one embodiment, the method 200 is based on the assumption that a user 120 will not face a hardship forever. The account obligations/terms (and various terms in various agreements) may be flexibly changed over time. For example, an account term (such as a term in an agreement) may be modified, by the obligation circuit 103, such that a user 120 avoids negative consequences to the user's 120 credit report. Operations of the method 200 may be conducted by the interactive communication platform computing system 100 (e.g., provider institution computing system 110 and/or user device 121).

In some embodiments method 200 may begin in response to a user 120 identifying a hardship and determining to receive assistance regarding one or more terms (or obligations) of an existing agreement using the provider institution client application 125. For example, a user 120 may determine to receive assistance regarding one or more terms of their existing agreement in response to giving birth and taking a leave of absence from work for three months. In other embodiments, method 200 may begin in response to the user 120 receiving an indication or other alert from the provider institution circuit 115.

In some embodiments, the user 120, in response to identifying a hardship and determining to receive assistance about one or more terms of an existing agreement, may open and be authenticated into the provider institution client application 125 by the user device 121. Based on receiving an indication of a hardship, the provider institution client application 125 may initiate an interactive communication session to revise term(s) of the existing agreement. Accordingly, the provider institution client application 125 may transmit a request to the provider institution circuit 115 at 202 to modify one or more user 120 obligations under the agreement (such as payment obligations). The provider institution circuit 115 may identify the user device 121 as the source of the request based on identifying information regarding the user device 121 (e.g., device identifier, MAC address, etc.). That way, when the interactive communication session is initiated, the session is initiated with the appropriate user device.

In other embodiments, the provider institution circuit 115 may transmit an alert or other notification (e.g., reminder) to user device 121 indicating that the user 120 is able to revise the terms of the agreement if the user 120 initiates a communication session by requesting a term revision (e.g., requesting to revise and/or update an obligation). The provider institution computing system 110 may determine to transmit a reminder in response to monitoring the user account and determining a predicted state of the user 120. Determining the predicted state of the user may include determining whether the user 120 has missed (or will likely miss) a predetermined number of threshold events (e.g., making monthly payments). For example, the provider institution computing system 110 may transmit a notification reminding the user 120 that they can revise the terms of an agreement if the user 120 misses a predefined number of payments. The provider institution computing system 110 may monitor the user account (in response to receiving authorization from the user 120 in the form of an acknowledgement and/or user credentials) to determine whether the user 120 has made payments or missed payments. Monitoring one or more user accounts may include determining that a threshold number of one or more trigger events has occurred, where a trigger event may be a failure to perform a term in the agreement, for instance. Monitoring the user 120 account may also include monitoring whether payments received in the user account have reduced by a threshold amount (e.g., by 25%).

The provider institution computing system 110, and particularly the provider institution circuit 115, may initiate a communication session with the provider institution client application 125 based on receiving the request from the provider institution client application 125 at 202 or based on determining that the user has missed (or will likely miss) a predetermined number of threshold events, for example. The communication session may be initiated via the provider institution circuit 115 setting up a communication link with the provider institution client application 125 at the user device 121. The communication link may initiate a chat bot or other virtual agent to communicate with the user 120 regarding the user's hardship and obligations of an existing agreement. The communication session is used to determine one or more revised terms of the existing agreement using an iterative query/response communication with the user 120 where each user response is evaluated using the confidence determination circuit 109 to determine the “confidence” (or, confidence value, score, indicator, etc.), or the user's belief in their conviction to satisfy one or more proposed obligations. In some embodiments, before the communication session is initiated, the user 120 may provide credentials to be authenticated and verified via the authentication circuit 106.

In some embodiments and as alluded to above, the provider institution circuit 115 may automatically initiate the communication link (i.e., and the interactive communication session using the chat bot or other virtual agent to communicate with the user 120 regarding the user's hardship and obligations) in response to the user 120 not satisfying a particular obligation relative to a threshold (e.g., missing a predefined number of periodic payments, being late a predefined number of times consistently, being short on payments by a predefined amount a predefined number of times, some combination thereof, etc.). In this embodiment, the reception circuit 104 may not need to receive a request before initiating the provider institution circuit 115 of the provider institution computing system 110 and, in contrast, the interactive communication session is automatically initiated. This may be advantageous in identifying potential troubled accounts. In other embodiments, the provider institution circuit 115 may automatically initiate the communication link but freeze the interactive communication session until the user 120 is authenticated using the authentication circuit 106.

In some embodiments, before the communication session is initiated, the user 120 may provide credentials to be authenticated and verified via the authentication circuit 106. In one embodiment, the authentication credentials are received by the client application 125 before an indication of a hardship is received (i.e., to enable access to the client application 125 to provide the indication). In another embodiment, a first set of authentication credentials are received to access the client application 125 (e.g., a face biometric) and a second set of authentication credentials are received to initiate the communication session (e.g., biometric information, passcode, password, a secure passkey specific to the account, answer to a security question, etc.).

In certain embodiments, initiation of the communication session may be done in person at a branch location of the provider institution. In this situation, a user 120 may provide their authentication credentials to access the application 125. Prior to, subsequent to, or contemporaneously with, the user 120 may tell an attendant information regarding their account. The attendant may verify their information, and then enable them to initiate the communication session by providing them with a code. The code may be an optically scanned code (e.g., QR code, barcode, etc.) that the user device 121 captures via the camera which is a specific authentication for using and initiating the communication session. In another embodiment, the user 120 taps their device to a short-range communication device (e.g., PIN pad at the branch) to be authenticated (e.g., by transmitting a token, such as a device token, that is correlated to a specific account of the provider institution computing system 110 to confirm that the user device 121 is associated with that account). Once confirmed, the communication session is initiated. In another embodiment, the user device 120 receives a token from the short range communication device at the branch that enables the user device 120, via the client application 125, to pass that received token to the provider institution computing system 110 to then initiate the communication session. In each of these instances, computing resources may be managed such that a communication session is only initiated in certain, limited circumstances.

Once the interaction communication session is started, a chat between the user 120 and the virtual agent (e.g., chat bot) is commenced regarding the user's hardship. The provider institution circuit 115 may transmit a question or prompt about a term in the existing agreement at 204 using, for example, the prompt circuit 105 (e.g., the FFIEC questions as described above initially followed by personalized prompts). The user 120 may receive the question about the term as a question coming from the virtual agent such that the communication session mirrors a conversation (or chat) between two people. As discussed herein, the prompt circuit 105 includes selecting questions based on the results of a machine learning model, selecting questions based on a predetermined sequence of questions, selecting questions based on mapped questions associated with user inputs, and the like

The user 120 receives the prompts via the reception circuit 131 at the user device 121 and inputs a user response to be communicated to the provider institution computing system 110 via the response circuit 130. User responses (audio, graphic, and/or text responses) may be received by the reception circuit 104 and analyzed at the provider institution computing system 110 using one or more circuits (such as the machine learning circuit 111, the NLP circuit 108, and/or the OCR circuit 117, the confidence determination circuit 109) to determine whether the user 120 is truly confident in their ability to satisfy an obligation in the prompt transmitted to the user (i.e., does the confidence determination circuit 109 believe that the user 120 has high, medium, or low confidence when the user 120 says that he/she can satisfy a proposed term). As discussed herein, the confidence determination circuit 109 may use a received user confidence to determine a true confidence value that is subsequently compared to a confidence threshold to determine or assess the likelihood of the user to satisfy one or more revised/updated payment obligations.

If the confidence determination circuit 109 determines that the user 120 is not confident (i.e., the determined confidence is below the confidence threshold), then the obligation circuit 103 may revise/update a term or obligation of the agreement at 205. The obligation circuit 103 proposes a new term based on the user confidence determined or extracted from the user response received by the reception circuit 104. In some embodiments, the user 120 may identify a particular term of the agreement that the user 120 is not confident in satisfying. Accordingly, the obligation circuit 103 may modify the specific term at 205, and a question or prompt with the modified term may be selected by the prompt circuit 105 and transmitted to the user device at 204. In other embodiments, the user 120 may not identify a particular term of the agreement that the user 120 is not confident in satisfying. Accordingly, the obligation circuit 103 may modify one or more terms at 205 and the prompt circuit 105 may select prompts using the one or more modified terms and/or may select broad prompts to be transmitted to the user device 121 at 204.

The prompt circuit 105 iteratively selects prompts to be communicated to the user device 121 at 204. The confidence determination circuit 109 iteratively determines whether the user's true confidence satisfies the confidence threshold at 206. The obligation circuit 103 iteratively revises one or more terms/obligations in the agreement at 205. Operations 204-206 iterate until the confidence determination circuit 109 determines that the user 120 is confident with the proposed terms at 206 (e.g., the determined user's true confidence meets or exceeds a predefined confidence threshold).

In some embodiments, when the confidence determination circuit 109 determines that the user is truly confident in their ability to satisfy a term in the prompt transmitted to the user (i.e., the true confidence meets or exceeds the predefined confidence threshold), the prompt circuit 105 may transmit a prompt about the agreement (including the modified terms of the agreement) at 208. The confidence determination circuit 109 determines the confidence associated with the user response with respect to the agreement as a whole (including the modified terms of the agreement). Accordingly, the confidence determination circuit 109 may determine the user's confidence in satisfying the agreement as a whole (as opposed to one or more terms of the agreement). In some embodiments, the confidence determination circuit 109 may employ different confidence thresholds for different confidence determinations. For example, the confidence threshold associated with evaluating the user's confidence with the agreement (at 210) may be different from the confidence threshold associated with the user's confidence with one or more particular terms of the agreement (at 206). As described herein, the confidence threshold may be a quantitative or qualitative value (e.g., a number on a scale, such as 70 out of 100, or a qualitative rating, such as “high confidence”). If the confidence determination circuit 109 at 210 determines that the user is not confident about the agreement in response to the confidence score not satisfying the confidence threshold, then the obligation circuit 103 may revise a term in the agreement at 211. The obligation circuit 103 proposes a new/modified term based on the user confidence extracted from the user response. Accordingly, the iterative process of evaluating the user's confidence with respect to terms of the agreement repeats.

The prompt circuit 105 iteratively selects prompts to be communicated to the user device 121 at 204. The confidence determination circuit 109 iteratively determines whether the confidence extracted from the user response satisfies the confidence threshold at 206. The obligation circuit 103 iteratively revises one or more terms/obligations in the agreement at 205. Operations 204-206 iterate until the confidence determination circuit 109 determines that the user 120 is confident with the proposed terms at 206 (e.g., the determined user's true confidence meets or exceeds a predefined confidence threshold).

In some embodiments, the user 120 may identify a particular term of the agreement that the user 120 is not confident in satisfying. Accordingly, the obligation circuit 103 may modify the particular term at 205, and a question or prompt with the modified term may be selected by the prompt circuit 105 and transmitted to the user device 121 at 204. In other embodiments, the user 120 may not identify a particular term of the agreement that the user 120 is not confident in satisfying. Accordingly, the obligation circuit 103 may modify one or more terms at 205 and the prompt circuit 105 may select prompts using the one or more modified terms and/or may select broad prompts to be transmitted to the user device 121 at 204.

If the confidence determination circuit 109 determines that the user is confident about the agreement at 210 (e.g., the determined user's true confidence meets or exceeds a predefined confidence threshold), then the provider institution computing system 110 may transmit the terms of the agreement to the user device 121 at 212 and/or initiate payment at 214. In other embodiments, when the confidence determination circuit 109 determines that the user 120 is confident with the proposed terms at 206 (e.g., the determined user's true confidence meets or exceeds a predefined confidence threshold), then the provider institution computing system 110 may transmit the terms of the agreement to the user device 121 at 212 and/or may initiate payment of a balance or payment to satisfy the updated/modified term (or obligation) at 214.

In operation, the provider institution computing system 110 may transmit the terms of the agreement to the user device 121 at 212 such that the user 120 may review the terms of the agreement and/or store the agreement in memory 126. The terms of the agreement may include at least a revised term, where the revised term is based on the user 120 input (e.g., the user's confidence associated with the revised term).

The terms of the agreement may be an acknowledgement of what the user 120 has agreed to (e.g., the terms that the confidence determination circuit 109 determined that the user 120 is likely able to satisfy/meet), when the user 120 will begin their first payment and any subsequent payments, whether the user 120 agreed to reminders, and the like. Depending on the agreement, terms of the agreement, user 120 preferences, or other provider institution computing system 110 preferences, the provider institution computing system 110 may transmit a document for the user 120 to sign and/or acknowledge summarizing the agreement and/or terms of the agreement (including the revised terms). The user 120 may sign and/or acknowledge the agreement using an electronic signature, for instance. Additionally or alternatively, the user 120 may physically sign the agreement and scan the signed agreement into the provider institution client application 125. The signed and/or acknowledged documents may be saved in memory 126 of the user device 121 and/or memory 116 of the provider institution computing system. In some configurations, the provider institution client application 125 may copy the signed and/or acknowledged documents before transmitting the documents to the provider institution circuit 115. Otherwise, a user's 120 consent to the terms (e.g., verbal consent and/or written consent) during the communication session with the chat bot/virtual agent of the provider institution circuit 115 may be sufficient to initiate the revised terms.

Subsequently, the provider institution circuit 115 may initiate payment of a balance or payment to satisfy the updated/modified term (or obligation) at 214. For example, the provider institution circuit 115 may initiate payment of one or more terms of the agreement by transmitting one or more links to the user device 121. Each link may be associated with a channel, where each channel is a payment option that is configured to pull funds from a user account. Links can be transmitted to the user 120 in the form of hyperlinks, icons, pop-up windows, buttons, and the like. For example, after agreeing to updated terms of the agreement, the provider institution circuit 115 may transmit a link to initiate payment. The link may include the user's Paypal account, Venmo Account, bank account, the provider institution computing system 110's website (or application), or any other third party payment provider, among others. The user 120 may interact with the link to automatically pay or facilitate payment to the provider institution computing system 110. For example, the provider institution computing system 110 may transmit a button to the user 120 such that the user 120 automatically authorizes the payment of the balance upon interacting with the button. In some embodiments, the user 120 may enter additional credentials and/or verify the user's authenticity before the payment is initiated (or after the payment is initiated) at 214.

Payment may be initiated (e.g., funds from a user account may be pulled) any time after the confidence determination circuit 109 determined that the user 120 is confident in satisfying the modified terms of the agreement. For example, after the user 120 has agreed to new terms (and the confidence score associated with the user response satisfies the confidence determination threshold), the provider institution system 110 may initiate payment. The provider institution system 110 may also initiate payment at future time (e.g., at the time the user 120 is supposed to make a payment according to the modified terms of the agreement). The provider institution system 110 may periodically initiate payment (e.g., every month, based on the terms of the agreement). The provider institution system 110 may also initiate payment several days before the payment is due.

In some embodiments, after the iterative method 200 has completed, the provider institution circuit 115 may periodically generate and transmit various notifications to the user device 121. In some the user 120 may initiate (e.g., log in, input credentials and be authenticated by the authentication circuit 106) the provider institution client application 125 to receive the notifications.

The notifications transmitted to the provider institution client application 125 from the provider institution circuit 115 include payment updates (e.g., a status report, an indication of a number of consecutive days/months/years that the user 120 has satisfied the terms of the agreement). Notifications also include positive reinforcement (e.g., high-five icons, star icons, inspirational words, sounds). Further, the provider institution computing system 110 may transmit financial information to the provider institution client application 125. For instance, the provider institution circuit 115 may determine an improvement to the user's 120 credit score (or other qualitative index) resulting from the user's 120 adherence to the revised terms by comparing the user's credit score at different points in time.

Referring now to FIG. 6, an example graphical user interface (“GUI”) 600 may be generated (e.g., via a user device 121 and/or provider institution computing system 110) illustrating an example chat between a virtual assistant (or chat bot operating via the provider institution circuit 115) and a user 120 using the provider institution client application 125 of the user device 121 during the interactive communication session.

A user 120 may have an account managed by the provider institution. The account may be associated with an agreement that defines a payment obligation such as a loan (e.g., mortgage, vehicle loan, etc.). Terms of the agreement may include a minimum payment amount, a payment due frequency (e.g., monthly, bi-monthly, etc.), a term of the payment obligation, a time frame, a minimum payment amount, an interest rate, whether prepayment is allowed, and so on. Accordingly and as described herein, the account may be a loan account or any other account that has a payment obligation. The user 120 may identify a hardship and determine to receive assistance regarding one or more terms (or obligations) of an existing agreement using the provider institution client application 125.

In some embodiments, the user 120, in response to identifying a hardship and determining to receive assistance about one or more terms of an existing agreement, may open and be authenticated into the provider institution client application 125. The user 120 may use the provider institution client application 125 to transmit an indication to the reception circuit 104 to initiate the interactive communication session shown in frame 610 to revise a term of an existing agreement. Frame 610 in graphical user interface (GUI) 600 may be generated by the provider institution client application 125 and displayed on the user device 121.

In other embodiments, the provider institution circuit 115 may transmit an alert or other notification (e.g., reminder) to user device 121 indicating that the user 120 is able to revise the terms of the agreement if the user 120 initiates a communication session by requesting a term revision (e.g., requesting to revise and/or update an obligation). The provider institution computing system 110 may determine to transmit a reminder in response to monitoring the user account and determining a predicted state of the user 120. Determining the predicted state of the user 120 may include determining whether the user 120 has missed (or will likely miss) a predetermined number of threshold events (e.g., making monthly payments). For example, the provider institution computing system 110 may transmit a notification reminding the user 120 that they can revise the terms of an agreement if the user 120 misses a predefined number of payments. The provider institution computing system 110 may monitor the user account (in response to receiving authorization from the user 120 in the form of an acknowledgement and/or user credentials) to determine whether the user 120 has made payments or missed payments. Monitoring one or more user accounts may include determining that a threshold number of one or more trigger events as occurred, where a trigger event may be a failure to perform a term in the agreement, for instance. Monitoring the user 120 account may also include monitoring whether payments received in the user account have reduced by a threshold amount (e.g., by 25%).

The provider institution computing system 110, and particularly the provider institution circuit 115, may initiate the communication session shown in frame 610 with the provider institution client application 125 based on receiving the request from the provider institution client application 125. The communication session may be initiated via the provider institution circuit 115 setting up a communication link with the provider institution client application 125 at the user device 121. The communication link may initiate a chat bot or other virtual agent to communicate with the user 120 regarding the user's hardship and obligations of an existing agreement. The communication session will be used to determine one or more revised terms of the existing agreement using an iterative query/response communication with the user 120 where each user response is evaluated using the confidence determination circuit 109 to determine an associated user confidence with the response. In some embodiments, before the communication session is initiated, the user 120 may provide credentials to be authenticated and verified via the authentication circuit 106.

In some embodiments, the provider institution circuit 115 may automatically initiate the communication link (and the interactive communication session using the chat bot or other virtual agent to communicate with the user 120 regarding the user's hardship and obligations) in response to the user 120 not satisfying a particular obligation relative to a threshold (e.g., missing a predefined number of periodic payments, being late a predefined number of times consistently, being short on payments by a predefined amount a predefined number of times, some combination thereof, etc.). In this embodiment, the reception circuit 104 may not need to receive a request before initiating the provider institution circuit 115 of the provider institution computing system 110 and, in contrast, the interactive communication session (as shown in frame 610) is automatically initiated. This may be advantageous in identifying potential troubled accounts. In other embodiments, the provider institution circuit 115 may automatically initiate the communication link but freeze the interactive communication session shown in frame 610 until the user 120 is authenticated using the authentication circuit 106.

Once the interaction communication session is started (e.g., the communication session between the user 120 and the virtual agent of the provider institution circuit 115 is active), a chat between the user 120 and the virtual agent may be initiated regarding the user's hardship. Frame 610 in GUI 600 shows responses and timestamps of a virtual assistant and user chat. The user 120 may interact with arrow 624 (e.g., using an input/output device) to scroll the frame 610.

In the example, the virtual assistant may initiate a communication session by popping frame 610 on a display of the user device 121. In the example, the user 120 may have already entered credentials and been authenticated to access the provider institution client application at 125. The provider institution computing system 110 initiates a conversation with the user 120 at 611 in response to monitoring a user account. In the example, the provider institution computing system 110 had been monitoring the user's 120 account and determined, based on a threshold number of previously missed payments, that the user 120 may want to revise a term.

As shown, the user 120 may respond to the virtual assistant's comment at 611 via response 612. The user 120 may type responses to the virtual assistant in text box 616 using input/output devices 128 of the user device 121. At 612, the user 120 agrees that the user 120 needs to revise a term agreement by acknowledging that the user 120 is not able to make payments.

As shown in 613, the virtual assistant may propose revisions to one or more terms of the agreement using the obligation circuit 103 and the prompt circuit 105 based on the user response at 612. The obligation circuit 103 and prompt circuit 105 may use extracted information from the user response at 612 (e.g., from the OCR circuit 117) and select a prompt to transmit to the user 120 with one or more revised agreement terms. As shown, the obligation circuit 103 selected a modified payment term and a modified duration term.

In some embodiments, the user 120 may respond to the prompt 613 received by the reception circuit 131 using text box 616. As shown in FIG. 6B, instead of (or in addition to) the text entry box 616, the provider institution client application 125 may generate and display a pop-up window 640. The user 120 may interact with a slider 642 to indicate the user's confidence in response to the virtual assistant's revised terms at 613 in FIG. 6A. The user response indicated with the slider 642 may be transmitted as a user response to the reception circuit 104. As shown in FIG. 6C, instead of (or in addition to) the text entry box 616, the provider institution client application 125 may generate and display a pop-up window 650. The user 120 may interact with a button of the plurality of buttons 652 displayed in the pop-up window 650 to indicate the user's confidence in response to the virtual assistant's revised terms at 613 in FIG. 6A. The user response indicated with the buttons 652 may be transmitted as a user response to the reception circuit 104. As shown in FIG. 6D, the user may respond with an explicit confidence in 662.

In the example, the confidence determination circuit 109 determined that the user 120 was confident in the user response because at 662 (i.e., the true confidence met or exceeded the confidence threshold), the prompt circuit 105 transmitted a prompt that thanked the user 120 for their cooperation and offered to be of further assistance at 664. If the confidence determination circuit 109 did not determine that the true confidence satisfies the confidence threshold, then the iterative communication session would continue to iterate until by transmitting prompts/obligations selected by the prompt circuit 105/obligation circuit 103 until the confidence determination circuit 109 determined that the true confidence score satisfied the confidence threshold.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computer-implemented method for an interactive communication session, comprising:
receiving, by a computing system, a request regarding a commitment associated with a user;
identifying, by the computing system, a user device as a source of the request;
initiating, by the computing system, an interactive communication session with the user device based on identifying the user device;
generating, by the computing system, a first prompt for inclusion in the interactive communication session, wherein the first prompt includes a first question regarding an expected duration of a hardship of the user;
providing, by the computing system, the first prompt in the interactive communication session such that the first prompt is provided via the user device;
receiving, by the computing system, a first reply to the first prompt from the interactive communication session;
generating and providing, by the computing system and based on the first reply, a second prompt in the interactive communication session, wherein the second prompt includes a second question regarding a modified commitment based on the first reply to the first prompt, and wherein the second prompt is determined via a reinforcement learning model trained to optimize a user confidence in satisfying the modified commitment;
receiving, by the computing system, a second reply to the second prompt from the interactive communication session;
analyzing, by the computing system and according to a machine learning model, the first reply and the second reply to determine a confidence of the user in satisfying the modified commitment, wherein the machine learning model is trained via supervised learning using data associated with a population of similarly situated users as the user;
comparing, by the computing system, the confidence to a predefined confidence threshold;
iteratively repeating the processes of generating a prompt via the reinforcement learning model, receiving a reply to the prompt, analyzing the reply according to the machine learning model to determine the confidence of the user, and comparing the confidence to the predefined confidence threshold until a determined confidence of the user meets or exceeds the predefined confidence threshold; and
transmitting, by the computing system, an updated term for the user based on the iterative process to the user device and storing the updated term in a memory of the computing system.

2. The computer-implemented method of claim 1, further comprising transmitting, by the computing system, a link for initiating settlement of a portion of the commitment.

3. The computer-implemented method of claim 1, wherein the updated term is an updated commitment amount.

4. The computer-implemented method of claim 3, further comprising providing, by the computing system, one or more links associated with one or more channels associated with settlement options to the user during the interactive communication session to initiate settlement for the updated commitment amount.

5. The computer-implemented method of claim 1, further comprising:
receiving, by the computing system, an authorization credential regarding the user at a third-party.

6. The computer-implemented method of claim 5, further comprising:
receiving, by the computing system, information from a third-party system associated with the third-party regarding the user; and
updating, by the computing system, the determined confidence based on the information from the third-party system.

7. The computer-implemented method of claim 1, further comprising:
monitoring, by the computing system, the user having the commitment; and
based on a determination of a delinquent event associated with the user, initiating, by the computing system, the interactive communication session with the user device to resolve the delinquent event.

8. The computer-implemented method of claim 1, wherein the first reply comprises at least one of a text entry, a slider entry, or an audio entry.

9. The computer-implemented method of claim 1, wherein the predefined confidence threshold is one of a qualitative threshold or a quantitative threshold.

10. An apparatus for an interactive communication session, the apparatus comprising:
a processing circuit comprising a processor and a memory coupled to the processor, the memory containing instructions therein that, when executed by the processor, cause the processing circuit to:
receive a request associated with a commitment;
select a prompt from a plurality of prompts, the selected prompt configured to illicit a user input from a user device associated with a user, the user input associated with revising the commitment;
continue to select at least one subsequent prompt from the plurality of prompts until the processing circuit determines that a received user input regarding a modified commitment included within the at least one subsequent prompt satisfies a predefined confidence threshold; and
transmit an indication including the modified commitment to the user device.

11. The apparatus of claim 10, wherein the instructions when executed by the processor, further cause the processing circuit to receive an explicit user input regarding a confidence in their ability to satisfy a modified commitment in the prompt, analyze the explicit user input based on a characteristic of the explicit user input, and determine a modified confidence based on the analysis regarding an ability of the user to satisfy the modified commitment.

12. The apparatus of claim 11, wherein the explicit user input is an audible input, and wherein the analysis includes natural language processing of the audible input to determine that a hesitancy was present in the audible input such that the determined modified confidence is less than a confidence articulated during the audible input.

13. The apparatus of claim 11, wherein determining that the received user input satisfied the predefined confidence threshold is based on determining a confidence value associated with the received user input by at least one of an optical character recognition algorithm or a natural language processing algorithm and comparing the confidence value to the predefined confidence threshold.

14. The apparatus of claim 10, wherein the instructions when executed by the processor, further cause the processing circuit to transmit a link associated with a settlement channel to facilitate a settlement to a third-party.

15. The apparatus of claim 10, wherein receiving user input associated with the modified commitment comprises at least one of receiving audio data, receiving text data, or receiving a selection from a predetermined list of user inputs.

16. The apparatus of claim 15, wherein the instructions when executed by the processor, further cause the processing circuit to receive audio data in response to an audio user response.

17. A computer-implemented method for an interactive communication session, the computer-implemented method comprising:
initiating, by a computing system, an interactive communication session with a user operating a user device;
providing, by the computing system, a chat bot that provides a prompt and receives a reply during the interactive communication session;
receiving, by the chat bot of the computing system, a request associated with a commitment of the user associated with the computing system;
iteratively proposing and receiving, by the chat bot of the computing system, a proposed revision to the commitment and a reply to the proposed revision to the commitment;
determining, by the computing system, that the reply regarding the proposed revision satisfies a predefined confidence threshold;
modifying, by the computing system, one or more commitments based on the proposed revision; and
transmitting, by the computing system, an agreement including the modified one or more commitments to the user device of the user.

18. The computer-implemented method of claim 17, further comprising receiving, by the computing system, a user signature in response to the transmitted agreement.

19. The computer-implemented method of claim 17, further comprising transmitting, by the computing system during the interactive communication session, one or more links associated with a settlement channel and initiating settlement associated with the agreement based on receiving a selection of the one or more links.

20. The computer-implemented method of claim 17, wherein the predefined confidence threshold is one of a qualitative threshold or a quantitative threshold.
